(19) United States
(12) Patent Application Publication
(10) Pub. No.: US 2012/0008604 A1
(43) Pub. Date: Jan. 12, 2012

(54) ENABLEMENT FOR REALLOCATED BANDWIDTH ENVIRONMENTS

(75) Inventors: Mika KASSLIN, Espoo (FI); Padam Kafle, Coppell, TX (US); Naveen Kakani, Coppell, TX (US)

(73) Assignee: NOKIA CORPORATION, Espoo (FI)

(21) Appl. No.: 12/833,148

(22) Filed: Jul. 9, 2010

(51) Int. Cl. H04W 84/02; H04W 4/00

(52) U.S. Cl. 370/338; 370/328

(57) ABSTRACT

A system for managing the enablement of beaconing in apparatuses operating in reallocated bandwidth corresponding to a geographic area. For example, apparatuses may initially determine whether they desire to operate as beaconing-type apparatuses or non-beaconing-type apparatuses. The apparatuses may then transmit enablement request frames comprising at least apparatus identification information and the previously determined desired beaconing or non-beaconing apparatus type. Apparatuses may then receive enablement request frames that at least designate the apparatuses as first tier beaconing apparatuses, second tier beaconing apparatuses or non-beaconing apparatuses. The apparatuses may then proceed to configure themselves based on the enablement information.

### BACKGROUND

1. Field of Invention

The present invention relates to operation in reallocated bandwidth environments, and in particular, to managing enablement of beaconing operations in such environments.

2. Background

Wireless communication technology continues to proliferate. As more and more apparatuses enter the marketplace, additional bandwidth must be made available to support their operation. Support for the expansion of operation within exclusive bandwidth (e.g., frequencies reserved for cellular communication) may just be a matter of communications providers buying the rights to additional reserved bandwidth. However as the total amount of available bandwidth is finite, it is getting increasingly difficult to reserve bandwidth to support emerging apparatuses. Unlicensed bandwidth provides a possible solution, but the provision of additional bandwidth in public use frequencies has been more problematic due in part to the growing number of devices operating in this area (e.g., peripheral devices such as headsets, keyboards, external storage, etc). In addition to the frequencies that are already available for unlicensed short-range wireless operation, U.S. regulators are now engaged in the reallocation of certain frequencies that were previously reserved for television (TV) broadcasts. While such reallocation may provide needed bandwidth for supporting short-range wireless communication in devices such as mobile handsets, the operation of new and legacy devices in the same space is not without its obstacles.

For example, the fact that certain frequencies in available spectrum are currently unused and may be reallocated for unlicensed short-range wireless communication does not eliminate all of the legacy operators (e.g., AM/FM radio, TV, etc.) that may still be active in the same, or nearby, frequencies. In this regard, the U.S. Federal Communications Commission (FCC) has decided that while TV white space (including frequencies that were previously reserved for TV channels but are not being currently used) may be reallocated for unlicensed broadband use, the apparatuses communicating in the unlicensed spectrum must still respect (avoid interfering with) any legacy operations. Active sensing is required as the frequencies used by legacy systems may vary geographically, resulting in different ranges of the spectrum being available in different areas. So, in addition to avoiding potential interference that may be caused by the many apparatuses interacting in the unlicensed bandwidth, the same apparatuses must also operate in accordance with the rules prohibiting interference with legacy apparatuses.

### SUMMARY

Various example embodiments of the present invention may be directed to methods, computer program products, apparatuses and systems for managing the enablement of beaconing in apparatuses operating in reallocated bandwidth corresponding to a geographic area. For example, apparatuses may initially determine whether they desire to operate as beaconing-type apparatuses or non-beaconing-type apparatuses. The apparatuses may then transmit enablement request frames comprising at least apparatus identification information and the previously determined desired beaconing or non-beaconing apparatus type. Apparatuses may then receive enablement request frames that at least designate the apparatuses as first tier beaconing apparatuses, second tier beaconing apparatuses or non-beaconing apparatuses. The apparatuses may then proceed to configure themselves based on the enablement information.

In at least one example implementation beaconing type apparatuses may correspond to apparatuses transmitting beacon signals in the IEEE 802.11 (WLAN) wireless communication protocol. The origin of the enabling signal may also affect how the enablement request frame is composed and then transmitted. For example, enablement request frames may have at least two formats, open format and vendor-specific format. Open format enablement request frames may require, in addition to the apparatus identification information and desired apparatus type, current location information for the apparatus. In instances where enablement request frame transmission is preceded by receipt of an enabling signal, if the enabling signal is received directly from an enabler, then the enablement request frame may be transmitted directly to the enabler. If the enabling signal is received from a first tier beaconing device (e.g., within a beacon signal), then the enablement request frame may be transmitted either to the first tier beaconing apparatus or to the enabler including a reference to the first tier enabling apparatus.

Enablement information may be received in response to the enablement request frames. The enablement information may be used in configuring the apparatuses. In accordance with at least one embodiment of the present invention, apparatuses designated as first tier beaconing apparatuses may be configured to transmit enabling signals to other apparatuses. This enabling signal transmission functionality may be configured alone or in combination with apparatuses designated as first tier beaconing apparatuses being configured to have a higher transmission power level than apparatuses designated as second tier beaconing apparatuses.

The foregoing summary includes example embodiments of the present invention that are not intended to be limiting. The above embodiments are used merely to explain selected aspects or steps that may be utilized in implementations of the present invention. However, it is readily apparent that one or more aspects, or steps, pertaining to an example embodiment can be combined with one or more aspects, or steps, of other embodiments to create new embodiments still within the scope of the present invention. Therefore, persons of ordinary skill in the art would appreciate that various embodiments of the present invention may incorporate aspects from other embodiments, or may be implemented in combination with other embodiments.

### DESCRIPTION OF DRAWINGS

The invention will be further understood from the following description of various example embodiments, taken in conjunction with appended drawings, in which:

FIG. 1 discloses example apparatuses, communication configuration and network architecture usable in implementing at least one embodiment of the present invention.

FIG. 2 discloses additional detail with respect to example communication interfaces that may be usable with various embodiments of the present invention.

FIG. 3 discloses an example of an operational environment in which at least one embodiment of the present invention may be implemented.

FIG. 4A discloses further detail regarding the example operational environment that was initially disclosed in FIG. 3.

FIG. 4B discloses examples of other potential signal sources that may exist in the example operational environment that was initially disclosed in FIG. 3.

FIG. 5A discloses a basic example of apparatus beaconing enablement in a geographic area accordance with at least one example embodiment of the present invention.

FIG. 5B discloses another basic example of apparatus beaconing enablement in a geographic area accordance with at least one example embodiment of the present invention.

FIG. 6 discloses a multiple tier operation within a geographic area in accordance with at least one embodiment of the present invention.

FIG. 7 discloses an example of apparatuses classified in multiple tiers within a geographic area accordance with at least one example embodiment of the present invention.

FIG. 8A discloses an example of messaging that may occur during beaconing enablement in accordance with at least one embodiment of the present invention.

FIG. 8B discloses an example communication flow that may occur during beaconing enablement in accordance with at least one embodiment of the present invention.

FIG. 8C discloses another example communication flow that may occur during beaconing enablement in accordance with at least one embodiment of the present invention.

FIG. 8D discloses a third example communication flow that may occur during beaconing enablement in accordance with at least one embodiment of the present invention.

FIG. 8E discloses a third example communication flow that may occur during beaconing enablement in accordance with at least one embodiment of the present invention.

FIG. 9 discloses a flowchart for a first portion of an apparatus beaconing enablement process in accordance with at least one embodiment of the present invention.

FIG. 10 discloses a flowchart for a second portion of an apparatus beaconing enablement process in accordance with at least one embodiment of the present invention.

### DESCRIPTION OF EXAMPLE EMBODIMENTS

While the invention has been described below in terms of a multitude of example embodiments, various changes can be made therein without departing from the spirit and scope of the invention, as described in the appended claims.

I. Example System with which Embodiments of the Present Invention May be Implemented

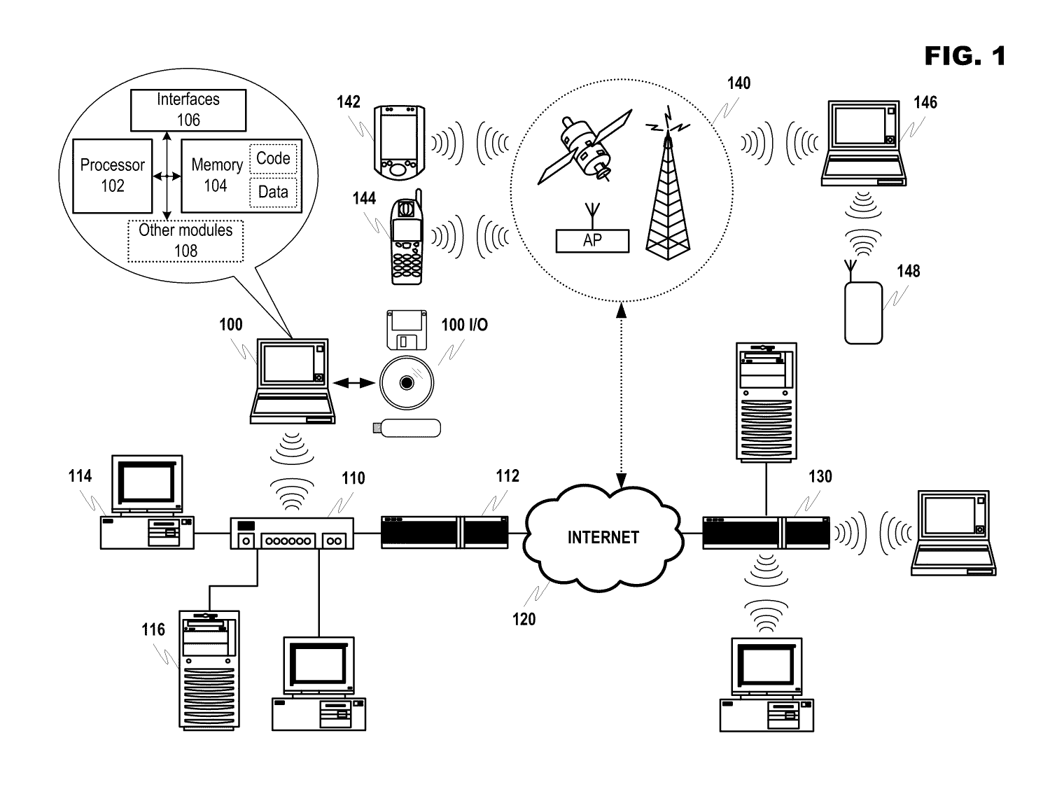

An example of a system that is usable for implementing various embodiments of the present invention is disclosed in FIG. 1. The system comprises elements that may be included in, or omitted from, configurations depending, for example, on the requirements of a particular application, and therefore, is not intended to limit present invention in any manner.

Computing device 100 may correspond to various processing-enabled apparatuses including, but not limited to, micro personal computers (UMPC), netbooks, laptop computers, desktop computers, engineering workstations, personal digital assistants (PDA), computerized watches, wired or wireless terminals/nodes/etc., mobile handsets, set-top boxes, personal video recorders (PVR), automatic teller machines (ATM), game consoles, or the like. Elements that represent basic example components comprising functional elements in computing device 100 are disclosed at 102-108. Processor 102 may include one or more devices configured to execute instructions. In at least one scenario, the execution of program code (e.g., groups of computer-executable instructions stored in a memory) by processor 102 may cause computing device 100 to perform processes including, for example, method steps that may result in data, events or other output activities. Processor 102 may be a dedicated (e.g., monolithic) microprocessor device, or may be part of a composite device such as an ASIC, gate array, multi-chip module (MCM), etc.

Processor 102 may be electronically coupled to other functional components in computing device 100 via a wired or wireless bus. For example, processor 102 may access memory 102 in order to obtain stored information (e.g., program code, data, etc.) for use during processing. Memory 104 may generally include removable or imbedded memories that operate in a static or dynamic mode. Further, memory 104 may include read only memories (ROM), random access memories (RAM), and rewritable memories such as Flash, EPROM, etc. Examples of removable storage media based on magnetic, electronic and/or optical technologies are shown at 100 I/O in FIG. 1, and may serve, for instance, as a data input/output means. Code may include any interpreted or compiled computer language including computer-executable instructions. The code and/or data may be used to create software modules such as operating systems, communication utilities, user interfaces, more specialized program modules, etc.

One or more interfaces 106 may also be coupled to various components in computing device 100. These interfaces may allow for inter-apparatus communication (e.g., a software or protocol interface), apparatus-to-apparatus communication (e.g., a wired or wireless communication interface) and even apparatus to user communication (e.g., a user interface). These interfaces allow components within computing device 100, other apparatuses and users to interact with computing device 100. Further, interfaces 106 may communicate machine-readable data, such as electronic, magnetic or optical signals embodied on a computer readable medium, or may translate the actions of users into activity that may be understood by computing device 100 (e.g., typing on a keyboard, speaking into the receiver of a cellular handset, touching an icon on a touch screen device, etc.) Interfaces 106 may further allow processor 102 and/or memory 104 to interact with other modules 108. For example, other modules 108 may comprise one or more components supporting more specialized functionality provided by computing device 100.

Computing device 100 may interact with other apparatuses via various networks as further shown in FIG. 1. For example, hub 110 may provide wired and/or wireless support to devices such as computer 114 and server 116. Hub 110 may be further coupled to router 112 that allows devices on the local area network (LAN) to interact with devices on a wide area network (WAN, such as Internet 120). In such a scenario, another router 130 may transmit information to, and receive information from, router 112 so that devices on each LAN may communicate. Further, all of the components depicted in this example configuration are not necessary for implementation of the present invention. For example, in the LAN serviced by router 130 no additional hub is needed since this functionality may be supported by the router.

Further, interaction with remote devices may be supported by various providers of short and long range wireless communication 140. These providers may use, for example, long range terrestrial-based cellular systems and satellite communication, and/or short-range wireless access points in order to provide a wireless connection to Internet 120. For example, personal digital assistant (PDA) 142 and cellular handset 144 may communicate with computing device 100 via an Internet connection provided by a provider of wireless communication 140. Similar functionality may be included in devices, such as laptop computer 146, in the form of hardware and/or software resources configured to allow short and/or long range wireless communication. Further, any or all of the disclosed apparatuses may engage in direct interaction, such as in the short-range wireless interaction shown between laptop 146 and wireless-enabled apparatus 148. Example wireless enabled apparatuses 148 may range from more complex standalone wireless-enabled devices to peripheral devices for supporting functionality in apparatuses like laptop 146.

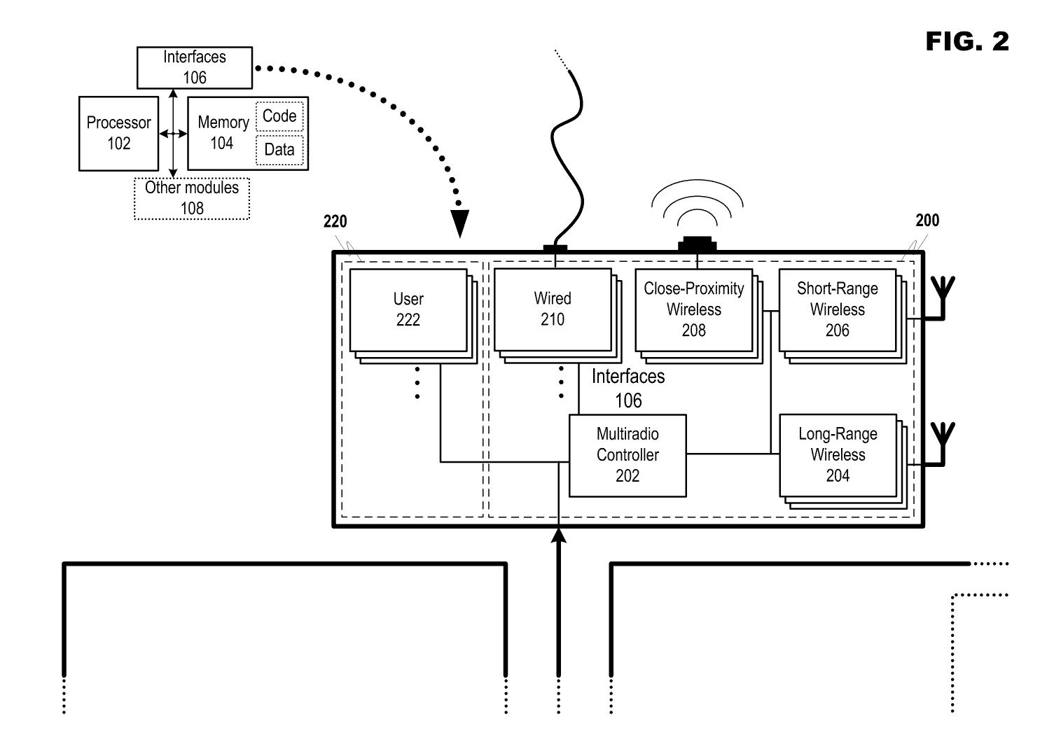

Further detail regarding example interface component 106, shown with respect to computing device 100 in FIG. 1, is now discussed with respect to FIG. 2. Initially, interfaces such as disclosed at 106 are not limited to use only with computing device 100, which is utilized herein only for the sake of explanation. As a result, interface features may be implemented in any of the apparatuses that are disclosed in FIG. 1 (e.g., 142, 144, etc.) As previously set forth, interfaces 106 may include interfaces both for communicating data to computing apparatus 100 (e.g., as identified at 200) and other types of interfaces 220 including, for example, user interface 222. A representative group of apparatus-level interfaces is disclosed at 200. For example, multiradio controller 202 may manage the interoperation of long range wireless interfaces 204 (e.g., cellular voice and data networks), short-range wireless interfaces 206 (e.g., Bluetooth and WLAN networks), close-proximity wireless interfaces 208 (e.g., for interactions where electronic, magnetic, electromagnetic and optical information scanners interpret machine-readable data), wired interfaces 210 (e.g., Ethernet), etc. The example interfaces shown in FIG. 2 have been presented only for the sake of explanation herein, and thus, are not intended to limit the various embodiments of the present invention to utilization of any particular interface. Embodiments of the present invention may also utilize interfaces that are not specifically identified in FIG. 2.

Multiradio controller 202 may manage the operation of some or all of interfaces 204-210. For example, multiradio controller 202 may prevent interfaces that could interfere with each other from operating at the same time by allocating specific time periods during which each interface is permitted to operate. Further, multiradio controller 202 may be able to process environmental information, such as sensed interference in the operational environment, to select an interface that will be more resilient to the interference. These multiradio control scenarios are not meant to encompass an exhaustive list of possible control functionality, but are merely given as examples of how multiradio controller 202 may interact with interfaces 204-210 in FIG. 2.

### II. Example Operational Environment

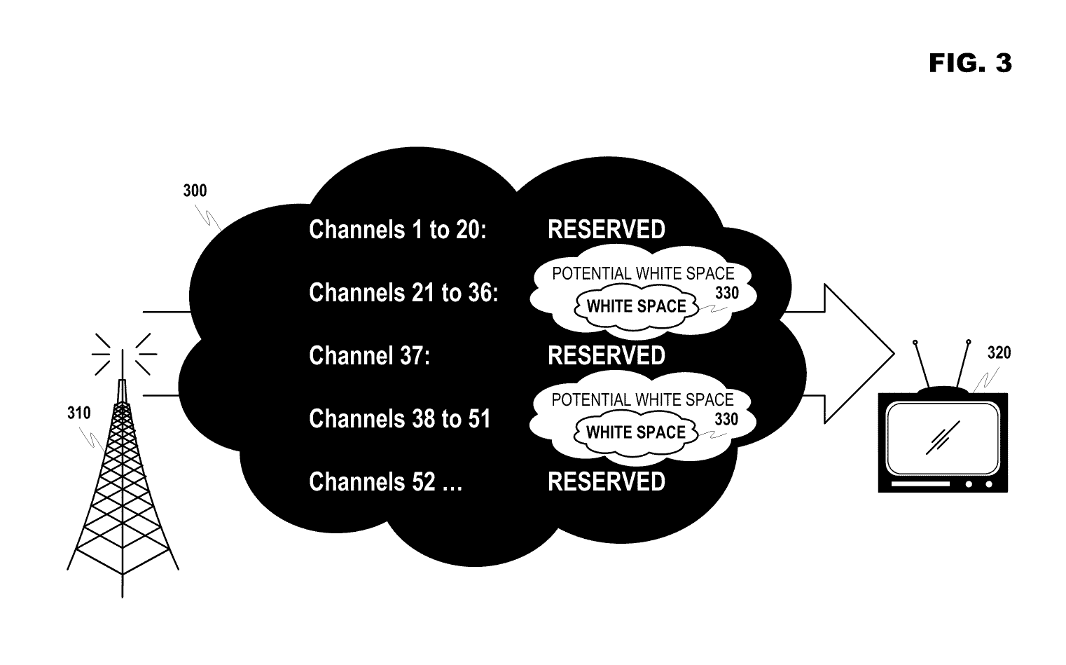

FIG. 3 discloses an example environment that will be utilized for explaining the various embodiments of the present invention. While a TV white space system will be utilized for the sake of example herein, the various example implementations of the present invention that will be disclosed below are not strictly limited only to this operational environment. As a result, various embodiments of the present invention may be applied to different situations that may have somewhat similar characteristics. For instance, such scenarios may include one or more apparatuses interacting wirelessly in an operational environment that is also experiencing substantial signal activity due to other signal sources that are also present in the environment.

FIG. 3 discloses an example of a rudimentary white space system. Initially, bandwidth 300 may be licensed to broadcasters 310. Bandwidth 300 may be separated into channels that are used by broadcasters 310 to send programming to TV 320. For example, each channel may be used by a broadcaster 310 to transmit audio/visual programming to TV 320, by wireless microphones, etc. However, some of bandwidth 300 that is licensed for TV programming may remain unused (e.g., there is no broadcaster using the channel, other signal sources may create interference within the frequency range that defines a channel, etc.). This unused space is identified in FIG. 3 as white space 330. White space 330 may therefore comprise some licensed bandwidth within bandwidth 300 that may be reallocated. TV white space (TVWS) in the U.S. may comprise TV channels 21-51, 470 MHz to 698 MHz, excluding channel 37. As a result, any channel that is not being used within the range of channels 21 to 36 and/or channels 38 to 51 may be reallocated for other uses, such as for unlicensed short-range wireless communication (e.g., allowing close-proximity wireless networks to be formed between apparatuses). There may also be unused VHF and UHF channels in which white space operation is permitted, but these channels are currently for fixed-to-fixed apparatus communication only.

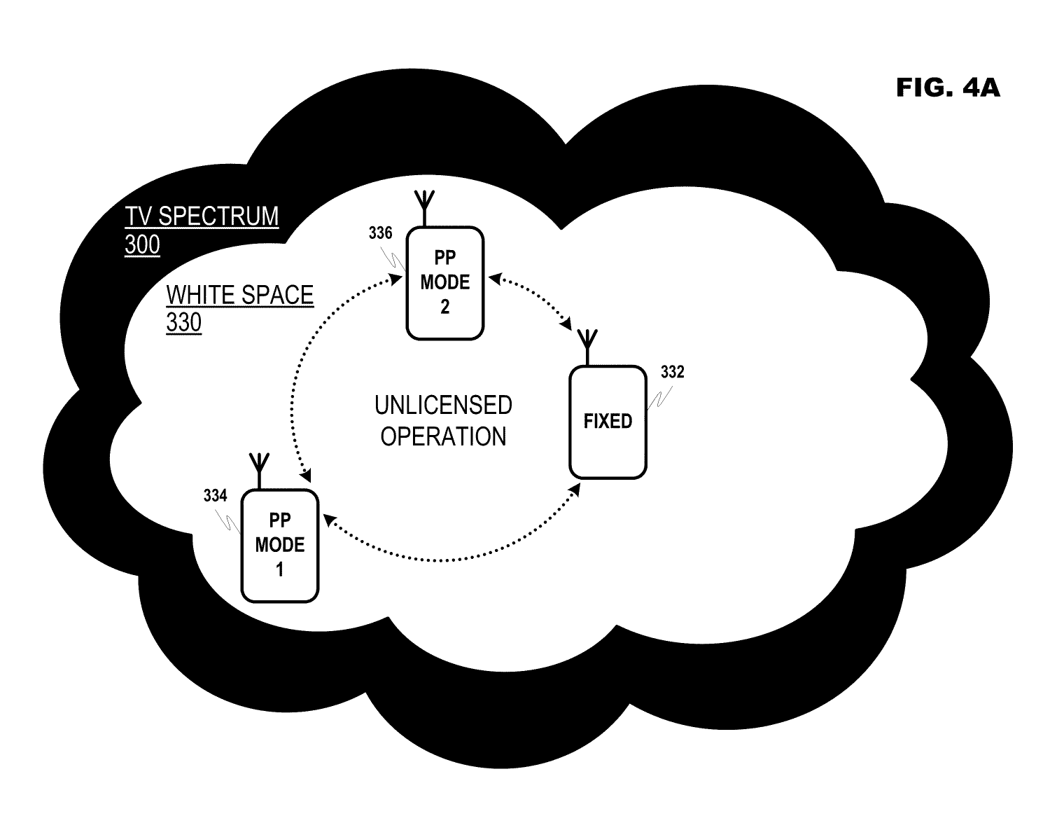

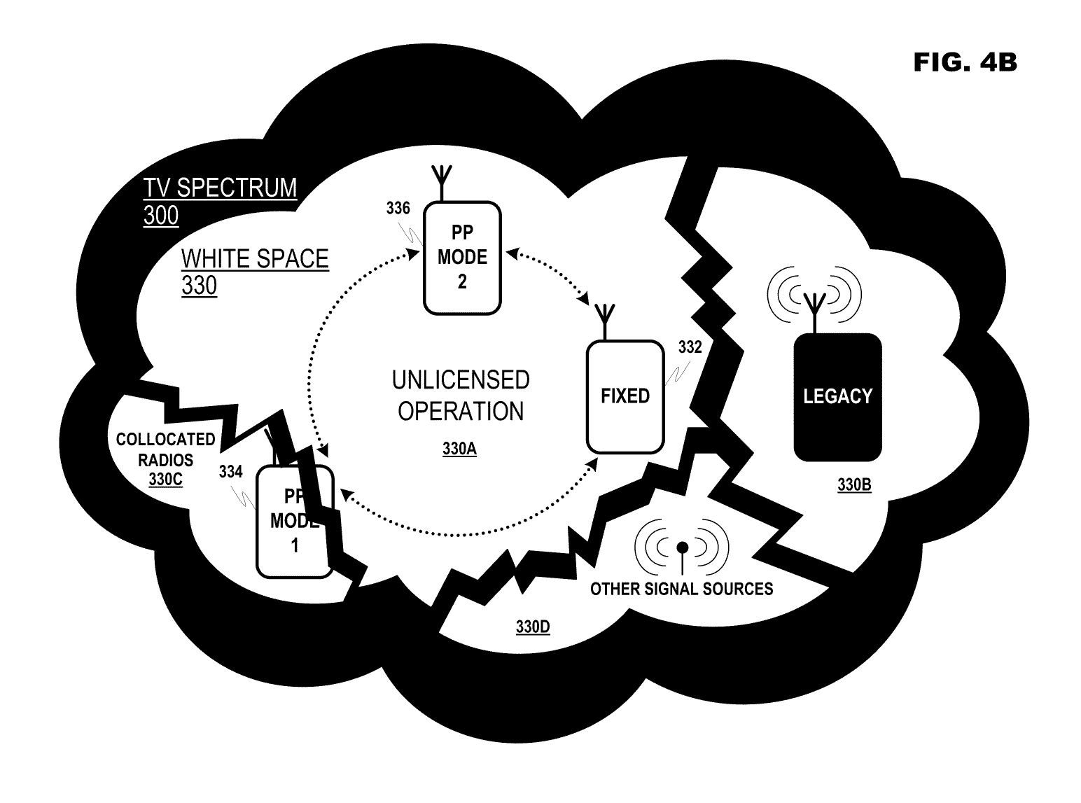

Now referring to FIG. 4A, the example of white space 330 as an environment in which apparatuses may interact is explored further. In TVWS network terminology there may be two categories of apparatus: fixed and personal/portable. Fixed apparatuses 334 are stationary, and thus, have a constant position over time. Personal/portable devices may be capable of moving, so their location may vary over time. Furthermore, personal/portable devices are categorized into PP Mode I apparatuses 334 and PP Mode II apparatuses 336. PP Mode II devices 336 can initiate networks (e.g., they can serve as access points in WLAN-type networks) as a master device. PP Mode I devices 334 can only operate as clients of TVWS networks, which may be controlled by either fixed apparatus 332 or PP Mode II device 336. Both fixed apparatuses 332 and personal/portable Mode II devices 336 may utilize spectrum sensing and database access to determine whether or not a channel is occupied by a primary user. In addition, a “special” type of apparatus (not pictured) may also be defined in TVWS networks. Such special apparatuses may be portable and may rely only on spectrum sensing to identify occupied channels.

Ideally, apparatuses 332, 334 and 336, as disclosed in FIG. 4A, may interact freely via wireless communication as long as they remain within the frequency range established for white space 330. However, in practice white space 330 may not be an ideal operational environment. This concept is discussed further with respect to FIG. 4B. In example scenarios where white space 330 is made available for unlicensed short-range wireless communication, many signal sources may exist within this frequency range, and as a result there may be many opportunities for interference to occur between these various sources. Initially, intra-apparatus interference (e.g., interference in an apparatus caused by other functionality occurring in the same apparatus) may exist. Co-located coexistence interference 330C means that devices may contain multiple radios that concurrently support wireless transports operating in proximate frequency bands, or that may otherwise still experience quality problems during simultaneous operation due to, for example, harmonic or inter-modulation interference. In this instance the multiple radios may cause interference between themselves. This is especially a problem if the apparatus is mobile cellular handset or other small factor device since the physical distance between the antennas is insubstantial (e.g., closer antennas=increased interference) and even the smallest leakage power can result in significant performance degradation. Transmission power level may also be a contributor to intra-apparatus interference, which may differ based on type of radio (e.g., cellular radio ˜2W is stronger than short-range unlicensed radio ˜100 mW).

The Quality of Service (QoS) delivered by wireless transports may also depend on the sensitivity of the radio technology being employed (e.g., how resistant is the technology to interference). For example, severe co-located interference may occur when a high power radio transmits at the same time when low power radio is receiving. For example, if a device supports both Long Term Evolution (LTE) operating at 700 MHz and TVWS technology using wireless local area network (WLAN) technology where the TVWS channel exists at high end of TV band (e.g., ˜690 MHz), the interference between LTE and TVWS technology can be substantial. The aforementioned case is just an example. Other combinations may also prove problematic. For example, other signal sources 330D may comprise apparatuses whose signals are present within the operational environment but are not part of the short-range unlicensed wireless network formed as disclosed at 330A. Other signal sources 330D may comprise, for example, electronic or electromechanical apparatuses whose operation causes electromagnetic field (EMF) interference in the operational environment. Moreover, wireless-enabled apparatuses that are operating close by but are not participating in unlicensed operation 330A may also contribute to signal traffic.

Such wireless-enabled apparatuses may prove extremely problematic in TVWS network systems since there may be very strict sensing requirements of incumbent users (e.g., legacy users 330B). For example, in TVWS systems a device may be requested to sense if a channel is used by a primary user before initiating any communication in that radio channel. Primary users may include, for example, TV broadcasters, wireless microphones or other protected devices. More specifically, the FCC is currently requiring that devices must operate using a −114 dBm detection sensitivity, which may be subject to change depending on various criteria such as updated wireless management regulations, changes in environment (traffic), etc. Sensitivity requirements may also be different depending on region (e.g., vary by country, etc.). As a result, any other co-located or close-by radio should interfere less than the above value to avoid false positive detections of primary users.

### III. Example Basic Enablement Interactions for a Certain Geographic Area

Initially, while the following disclosure makes specific reference to implementing WLAN in a TVWS environment, employing this particular protocol in this specific operational environment is utilized only for the sake of explanation herein. The various embodiments of the present invention are not limited only to implementing WLAN in a TVWS environment, but may also implement other wireless protocols in other situations where wireless beaconing, or other similar wireless operations, must be strictly controlled based on the particular geographic area.

Since the release of the FCC rule for Unlicensed Operation in the TV Broadcast Bands, TVWS spectrum is officially available in the U.S. for short-range wireless operation. TV band devices (TVBD) may operate in channels not being occupied by legacy users, which may include licensed TV broadcasters and wireless microphones. Wireless local area networking (WLAN) is one of the key technologies that is both suitable and desirable for TVWS spectrum. Apart from providing additional spectrum for supporting the operation of an expanding number of WLAN apparatuses emerging in the marketplace, another substantial advantage is that better propagation characteristics exist in the VHF or lower UHF TV bands, which can provide longer range than that is typically possible for existing WLAN systems operating in 2.4 or 5 GHz band.

The FCC regulations establish strict protection of existing primary services that operate in these channels. Apparatuses seeking to utilize the bandwidth for unlicensed short-range wireless communication are first required to seek permission by accessing databases that provide allowed operating channels/frequencies in accordance with reported apparatus location, to perform sensing to avoid interfering with legacy apparatus operation and to operate utilizing specified maximum transmit power levels for various device categories. As mentioned above, the FCC rules include two categories of TVBD devices: Fixed TVBD which are installed to a specific location and allowed to have a maximum transmit power of 4 W equivalent isotropically radiated power (EIRP), and personal/portable TVBD, which are restricted to a 100 mW EIRP maximum. There are currently two operational modes defined for TVBD: master mode and client mode. Fixed TVBD are required to include positioning and database access capabilities, and thus can operate as master mode stations. On the other hand, personal/portable devices can either operate in master mode (mode II operation) when equipped with positioning/database access, or operate in client mode (Mode I operation) under control of a master mode device where they must receive signals from a fixed TVBD or Mode II personal/portable TVBD before they can initiate transmissions in a channel frequency and will operate under control of its master device during this operation.

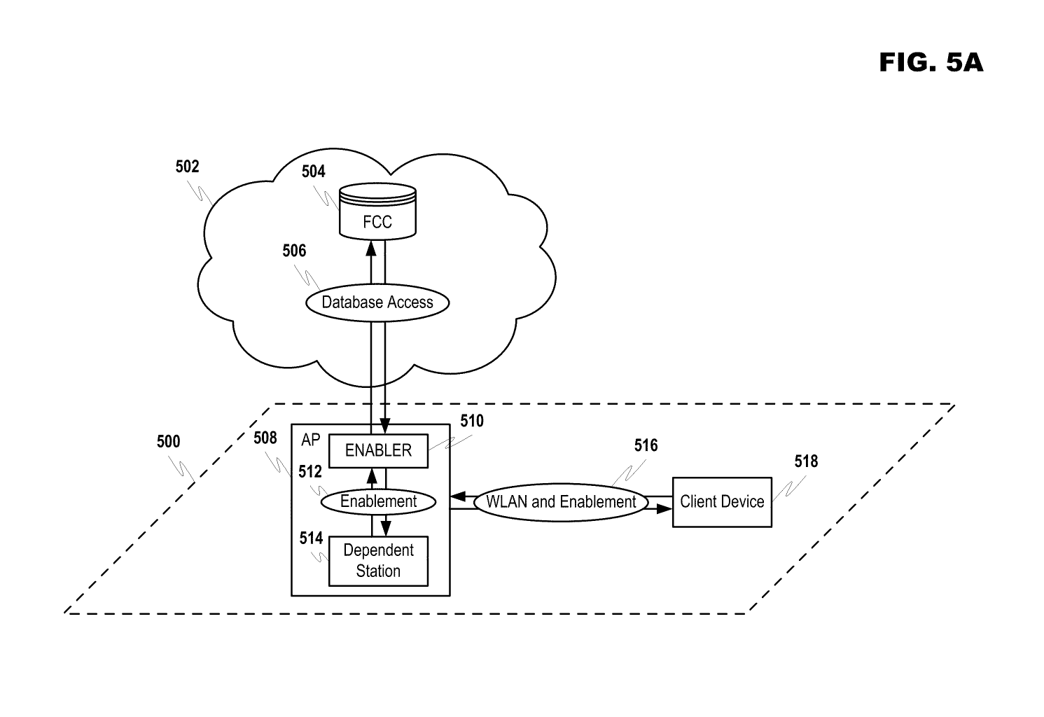

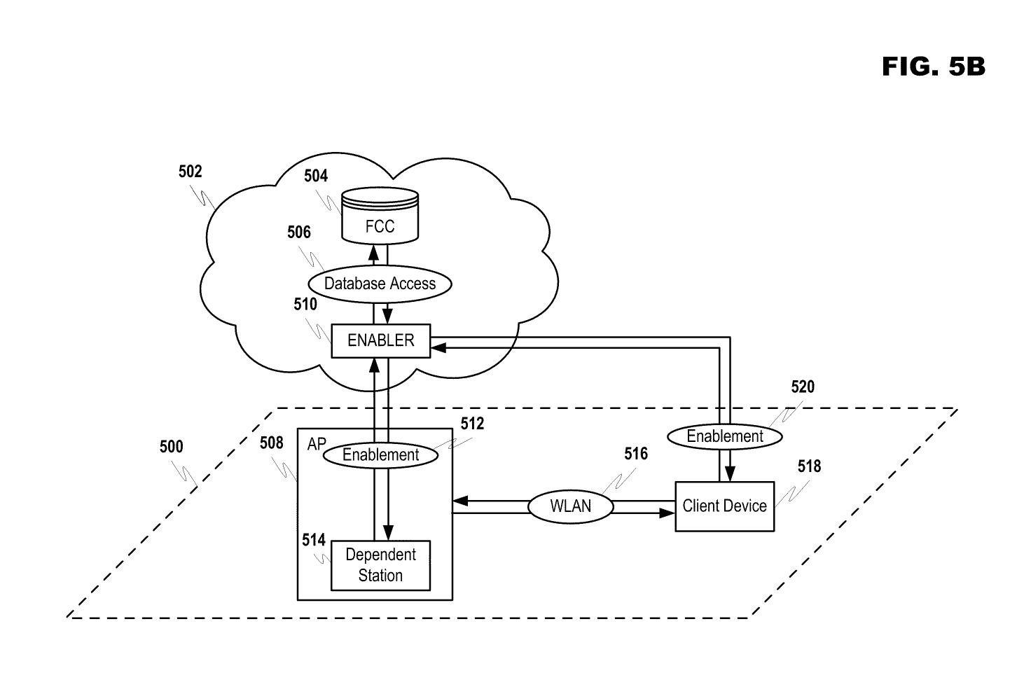

Existing thought on how to best implement WLAN in TVWS has centered around leveraging architecture and/or strategies set forth in the IEEE 802.11y revision of WLAN for use in WLAN implemented in TVWS, or IEEE 802.11af, which is currently being discussed at the IEEE task group level. FIG. 5A discloses a simple scenario of enabling access point (AP) 508. Area 500 defines a certain geographic location in which TVWS operation is permitted. At least AP 508 and client device 518 currently reside in area 500. In the course of seeking enablement, one or both of the apparatuses in area 500 may interact with FCC database 504, which may be situated remotely from area 500 as represented by cloud 502. For example, FCC database 504 may represent one or more servers that form a centralized database that provides allowed channel information to TVBD across the U.S., and thus, portions of FCC database 504 may reside in different locations that may all be accessible by a wide area network (WAN) such as the Internet.

AP 508 may comprise enabler 510 and dependent station 514. Enabler 510 may be a logical entity, meaning that enabler 510 may exist totally as software or as a combination of hardware and software, that is tasked with providing enablement services to other TVBD in area 500 like dependent station 514 and client device 518. As a prerequisite for performing this task, enabler 510 must first obtain allowed channel information for area 500 from FCC database 504, which is represented in FIG. 5A by database access 506. The frequency of database access 500 may be defined in the regulations promulgated by the FCC (e.g., at least once per day) in order to obtain updated allowed channel information from FCC database 504. Enabler 510 may then enable (send allowed channel and/or configuration information to) dependent station 514 in AP 508 as shown at 512. Enablement includes an exchange of information that will be discussed in more detail later on in the disclosure. Enablement 512 enables dependent station 514 to operate (e.g., perform beaconing) in area 500, which in turn allows AP 508 to advertise its presence and engage in wireless communication with other devices in area 500, such as client device 518. As WLAN is being utilized for the sake of example in FIG. 5A, a WLAN connection 516 may be established between AP 508 and client device 516. In a manner similar to enablement 512 of dependent station 514, client device 518 may communicate wirelessly over WLAN connection 516 with enabler 510 (via AP 508) in order to perform enablement operations, which enables client device 518 to participate in TVWS communication while within the bounds of area 500.

The scenario of FIG. 5A demonstrates that simple dynamic station enablement (DSE), as set forth in 802.11y, may also be employed when operating WLAN in TVWS areas without incurring any problems when additional regulatory requirements including spectrum sensing for allowed channels, enablement and in-service monitoring for legacy apparatus operation are performed. However, modification of the enabling signal message and enablement procedure will be useful even in this scenario such as for allowing enablement for multiple channels and for providing information regarding backup channels for channel switching.

Another example scenario is disclosed in FIG. 5B, in which case AP 508 of the basic service set (BSS) is not a master mode apparatus, since it does not include enabler 510, but instead operates under control of a master mode apparatus. Other apparatuses that may need to transmit beacons may be substituted for AP 500, for example a control station of an independent basic service set (IBSS) that may be responsible for beaconing and channel switching (when needed). Hence, dependent stations in such scenarios may be generally referred to as “beaconing dependent stations.” Enablement 512 of dependent station 514 in FIG. 5B may occur over a wired or wireless network, Internet, etc. Client device 516 may still communicate with AP 512 over WLAN 516, however, enablement 520 may engage enabler 510 with client device 518 via the same type of connection (e.g., WLAN 516) or via another medium. In general, master mode apparatuses need not be wireless devices themselves. For example, enabler 510 may reside in a server or network node responsible for enablement that is managed by an information technology (IT) department in an enterprise or other network provider. Enabler 510 may then be located in close proximity to the beaconing device, for example in the same building. In such instances the location of the enabling entity may also be valid for close-by dependent stations when seeking permission to operate from FCC enablement database 504. Otherwise, enabler 510 may be located remotely, in which case the beaconing station may be connected to enabler 510 via the Internet, cellular, satellite, etc. Regardless, enabler 510 is responsible for querying the FCC database in order to acquire a list of allowed channels for use by any devices under its control.

### IV. Example Tiered TVWS Architecture

While the basic systems disclosed in FIG. 5A-5B may operate in ideal situations, reality is not quite as ideal. The FCC TVWS rules specify that personal/portable devices have two possible operational modes. Apparatuses may operate utilizing Mode II functionality when access to the FCC database is available and the apparatus includes positioning capabilities, which allows apparatuses to access FCC database 504 in order to obtain the allowed channels on which to operate corresponding to their current location. Otherwise, apparatuses must operate in accordance with Mode I functionality that requires the apparatus to be under control of a master mode device, which removes the requirement for accessing FCC database 504.

In regard to WLAN BSS or IBSS, apparatuses may operate either as beaconing stations that may initiate networks in TVWS areas, or may just be simple clients that join existing networks. The general framework for enablement that has been introduced into the WLAN specification by the 802.11y amendment specifies that client apparatuses are generally referred to as “dependent stations” for which master devices may function as enabling stations in the 802.11y context. The 802.11y specification was developed for licensed operation of WLAN in 3650-3700 MHz band in the U.S., but it may also be generally applied to TVWS operation.

However, some scenarios associated with operating in TVWS are not addressed by the 802.11y specification. One problem is the particular functionality required by dependent stations when transmitting beacon signals. In at least one example implementation dependent stations may be required to provide initial enabling transmissions to other apparatuses in the BSS or IBSS so that these apparatuses will know how to access a master device (e.g., enabler) to request enablement. If enabling signals are required based on the system configuration, the beacons emitted by dependent stations therefore function as enabling signals that are receivable by other WLAN devices within transmission range so that these other client mode devices may request permission to operate in TVWS. 802.11y does not specify a procedure for providing enablement information from an enabler to a beaconing client apparatus to support beaconing in this manner. This is because an important objective when enabling a beaconing device in TVWS is to ascertain the position of the apparatus requesting enablement to ensure that the beaconing signal containing enabling information remains within the boundaries of the particular area for which an enabler is providing allowed channel information and/or control mechanisms. Existing WLAN specifications do not need to address such situations. Thus, new signaling mechanisms are necessary to extend the way enabling control signal and enablement procedure can work.

Another problem specific to applications like TVWS relates to enabling signal transmissions in scenarios where dependent stations are connected to enabling devices by other connectivity means as such wired connections or non-WLAN radios such as cellular links. The role of the enabling signal in such instances can vary when client devices are already aware of master devices and can utilize such alternative connectivity to initiate the enablement procedure, or even to request enabling signals for TVWS operation. Hence, simpler and more flexible mechanisms for client device permission in TVWS should be implemented. The protocol should allow client devices to initiate enablement for TVWS operation without the need to passively listen for control messages or only receive such signals in some specific periods for enablement.

In accordance with at least one embodiment of the present invention, a procedure for signaling message exchanges between dependent stations and enablers to address instances when dependent stations are transmitting beacon signals as enabling signals within the coverage area is proposed. Initially, the procedure may define the functionality of the beaconing station during enablement. The proposed method also resolves the boundary of enablement service area for the enabling device and mutual identity assertion. The signaling exchange for enablement and the role of transmitting enabling signal within the network may be managed by utilizing two tiers of beaconing devices: a first tier beaconing station that has the ability to request enablement using a preconfigured identity or using location obtained by its own positioning resources, and a second tier of beaconing device which may utilize the location information derived from enabling signals received from first tier beaconing stations. The proposed method also allows faster enablement to other dependent stations by providing the address of the enabling device.

The enabling signal message may also be extended to contain information of the backup channel(s) for possible channel switching, as well as extended to support an enablement procedure for multiple frequency channels. The enabling signal from a beaconing station may include the information about one or more backup channels for possible channel switches in the network when the current channel under operation ceases to be available (e.g., due to presence of protected primary signals in the channel). The enabling signal from an enabling station or a dependent beaconing station may also contain other frequency channels for which enablement may be offered by the enabling entity that supports faster channel switching opportunity without having to initiate new enablement procedures for each channel before switching to new channels.

In addition, a method of message exchange to request enabling signals from dependent stations when the dependent stations have alternate connectivity (other than a WLAN connection) to an enabler is also proposed. This method allows faster enablement initiation, as well as the ability to leverage earlier knowledge in client devices about enabler devices or the channels that support enablement when a client station has already established connectivity to its enabling station.

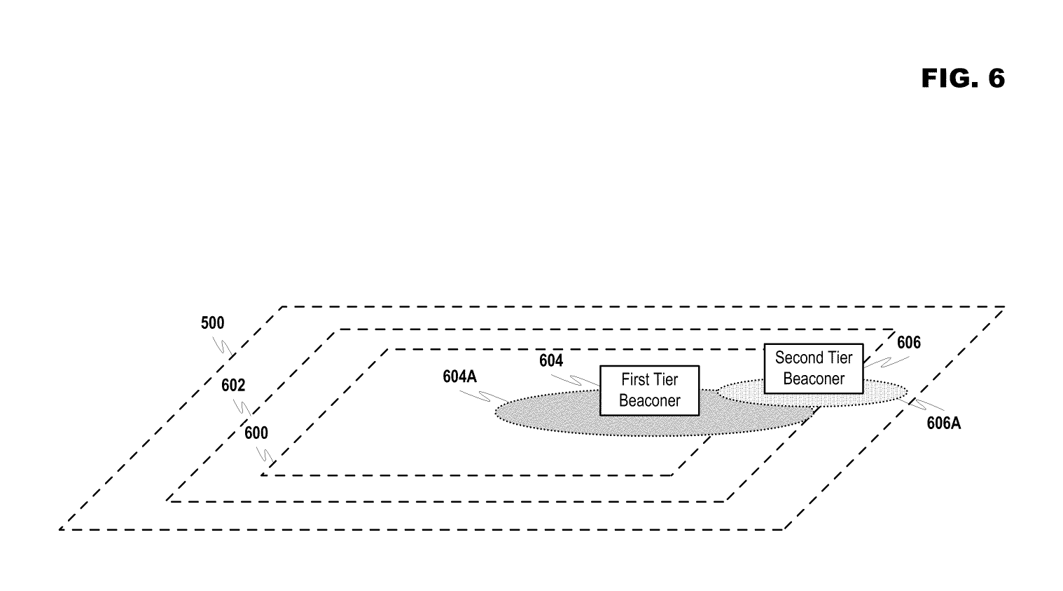

In accordance with at least one embodiment of the present invention, an example that may be utilized to understand the relationship between tiered apparatuses and geographic areas in which TVWS operation is supported is disclosed in FIG. 6. Area 500 may be divided into various regions such as sub-areas 600 and 602. The location of an apparatus in one of these areas may dictate a set of operational parameters that control the behavior of the apparatus. For example, apparatuses operating in sub-area 600 may be deemed first tier beaconing apparatuses (beaconer) 604. First tier beaconer 604 may be allowed to transmit beacons at a certain power level 604A and may be allowed to transmit enabling signals so that other apparatuses may request permission to operate in area 500. As further shown in FIG. 6, apparatuses that reside in sub-area 602 may be seemed second tier beaconers 606. Second tier beaconers may be allowed to operate in area 500 based on a different set of parameters, such as being allowed to transmit beacon signals at a lower power level as shown at 606A. Further, second tier beaconers may not be permitted to transmit enabling signals as part of their beacon signals. Different configurations for first tier beaconers 604 and second tier beaconers 606 allow the integrity of area 500 to be maintained by an enabler. More specifically, first tier beaconer 604 is located more centrally to area 500 (within sub-area 600), so there is less chance that apparatuses outside of area 500 will be able to receive beacon signals from these apparatuses. The minimal possibility of other apparatuses receiving beacon signals from first tier beaconer 604 also means that it is safe for enabling signals to be sent from these devices. However, in the example of FIG. 6 second tier beaconer 606 is much closer to the boundary of area 500 (within sub-area 602), so lower power level transmission is required to keep the beacons within area 500. Also, these apparatuses are not permitted to transmit enabling signals because devices outside of area 500 may receive them.

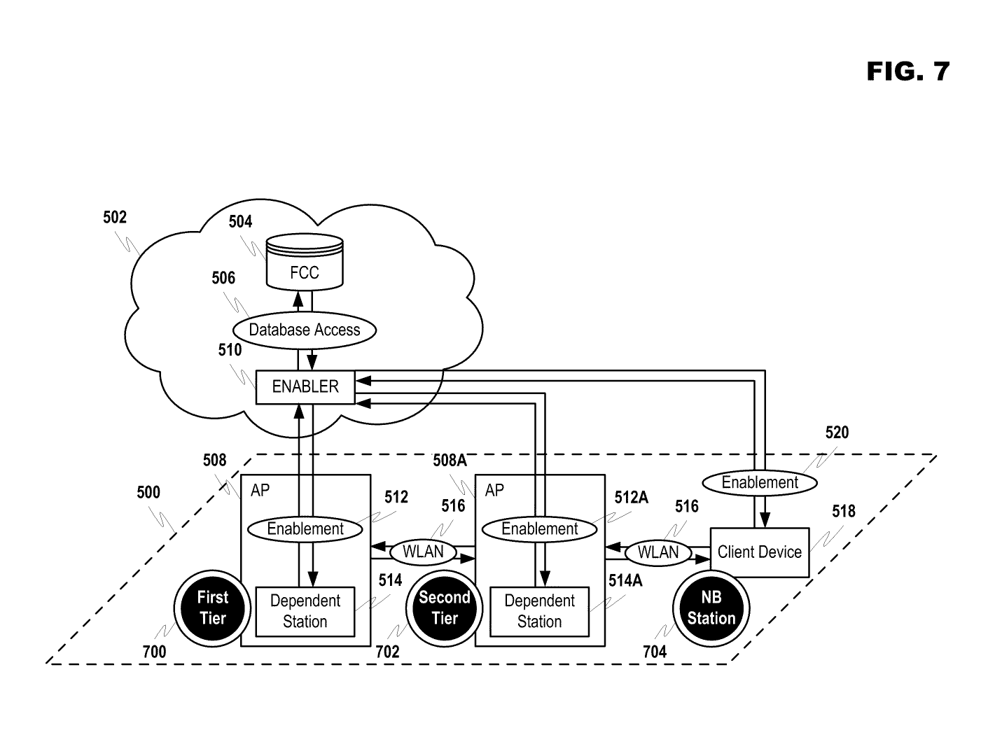

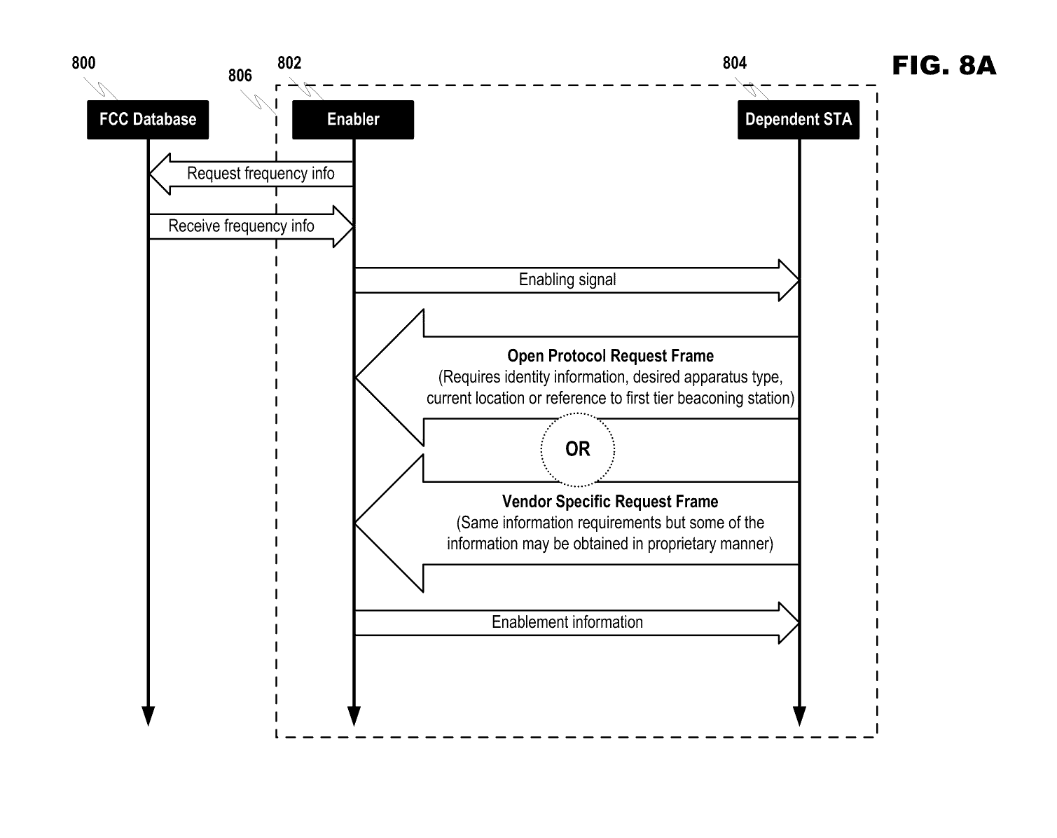

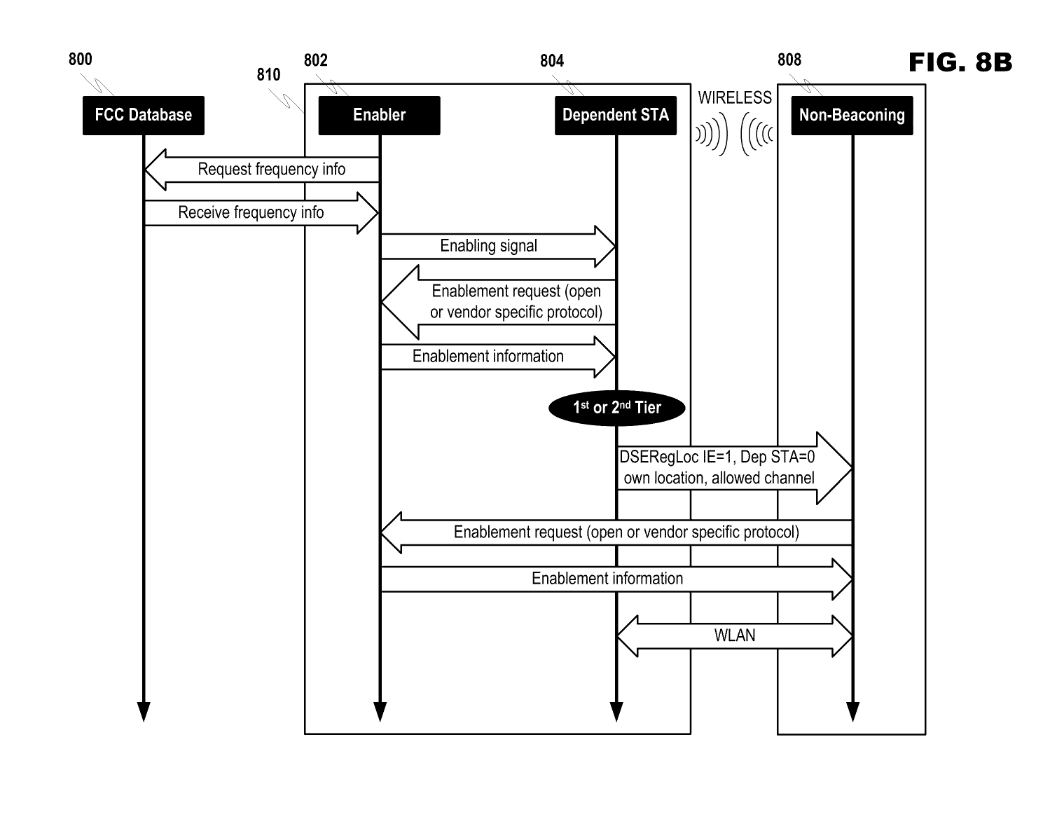

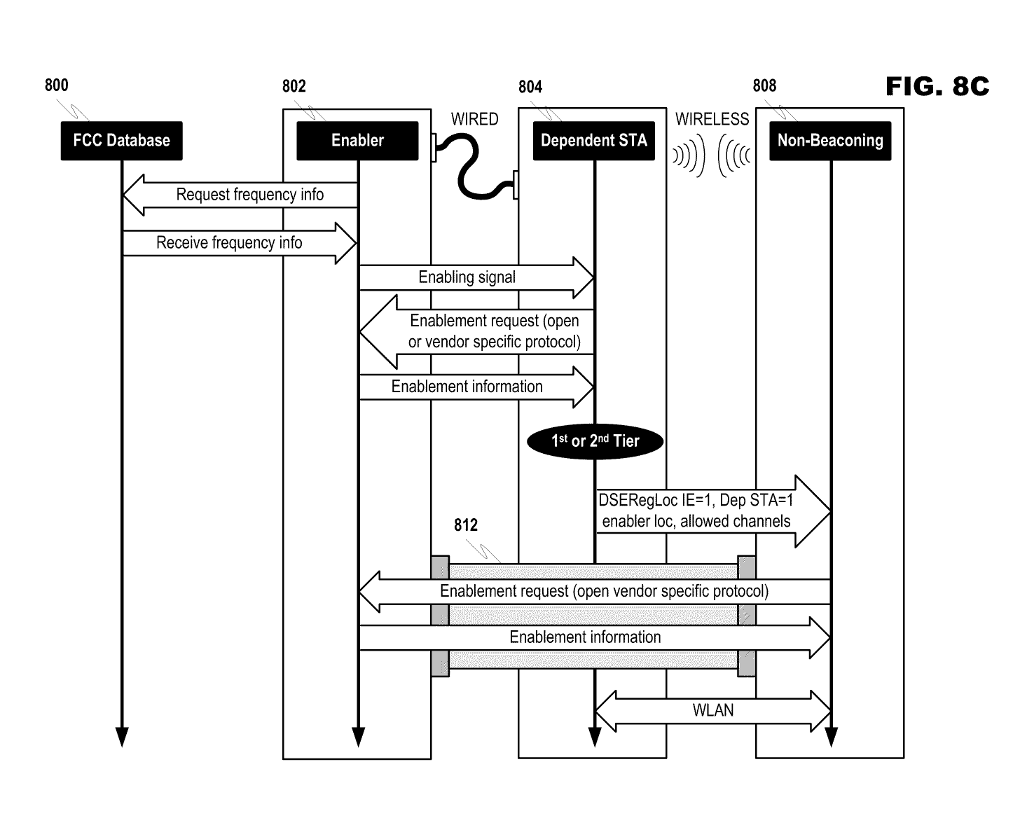

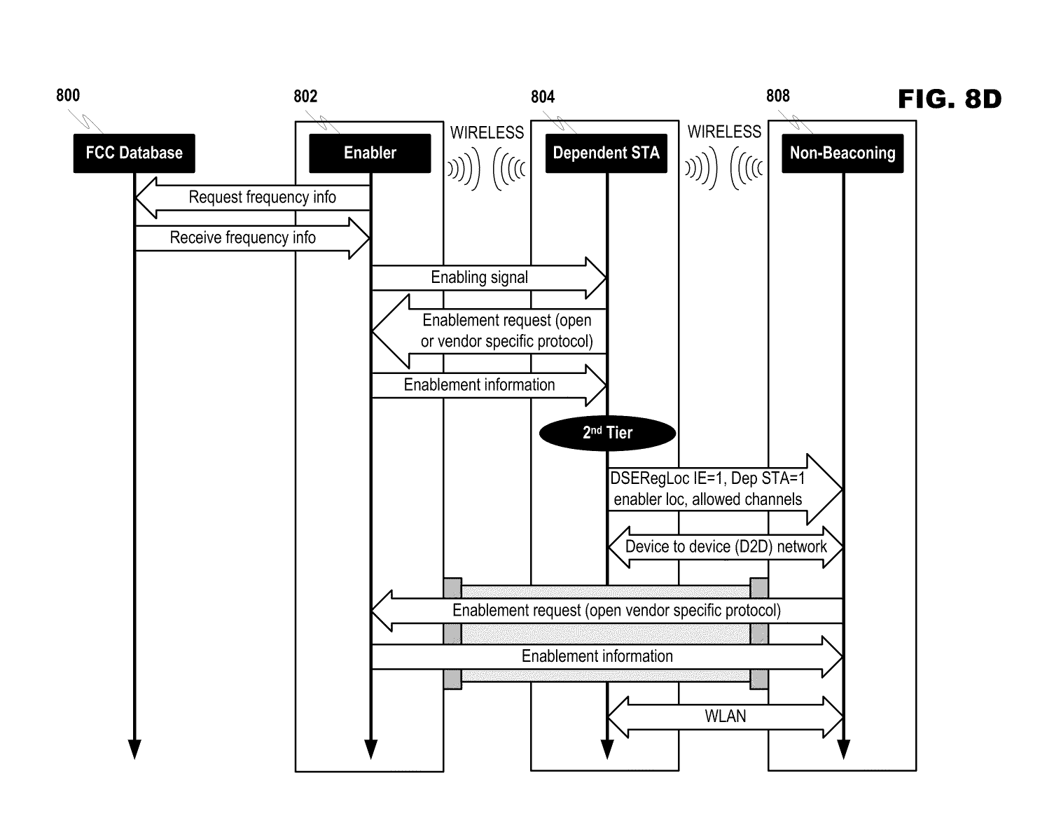

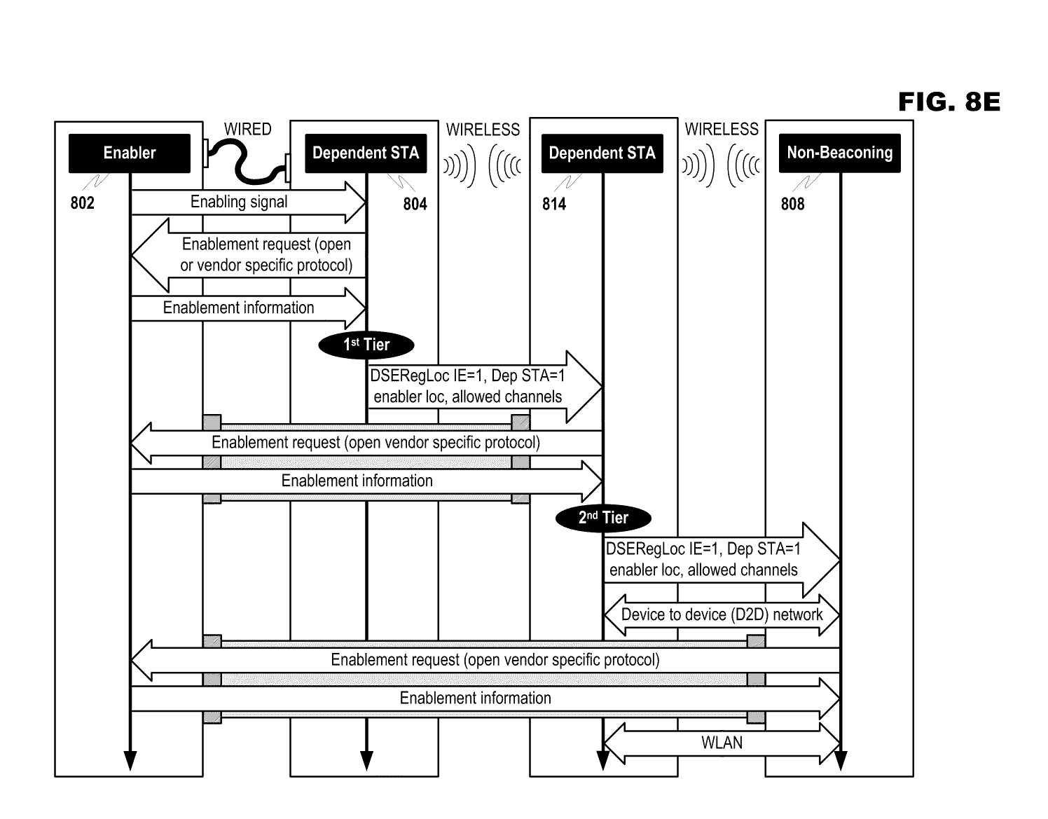

FIG. 7 discloses an example of first tier beaconing apparatuses 700, second tier beaconing apparatuses 702 and non-beaconing stations 704 interacting in accordance with the scenario set forth in FIGS. 5A and 5B. AP 508 from the previous example may serve as a first tier beaconing apparatus 700. Another similar access point 508A may be designated a second tier beaconing device 704 by enabler 510. It is important to note that while second tier beaconing apparatus 702 has been shown as an AP, any type of apparatus that is capable of performing beaconing operations (e.g., mobile wireless device) would also be acceptable. AP 508A may have similar structure as AP 508 including dependent station 514A, and may be enabled by enabler 510 as shown at 512A. Further, also communicating via WLAN 516 may be client station 518, which is also enabled by enabler 510 as shown at 520. Various example interactions in which messages are exchanged between these apparatuses are disclosed in FIG. 8A-8E.

It is possible that apparatuses may receive enabling signals via a dependent AP 508A, but would like to establish its own BSS or IBSS network instead of joining the same network. For example, the scenario is related to device-to-device (D2D) use cases for mobile devices in which devices want to utilize a third party enablement server available in an enterprise facility. Again, in the place of an AP, any other device that needs to transmit beacons is possible. Typically, an apparatus gets itself enabled by its enabling entity either by sending its location determined by its own positioning resources, or the location has been asserted through pre-configured identity with the enabling entity (for example, through upper layer signaling). Such devices are referred to as first tier beaconing stations that transmit enabling signals (e.g., embedded in its beacons). The enabling signal contains an indication that is specific to the first tier beaconer. A dependent station that receives such an enabling signal may use the identity information in the signal as a reference in its own enablement process to request to become a second tier beaconing station. Reception of enabling signals from first tier beaconing stations provides assurance for enablers that the requesting dependent station is in a location which is suitable for the dependent station to start beaconing as a second tier beaconing station. After being enabled, second tier beaconing stations can start transmitting their own beacons. However, such second tier beaconing stations can't be used as location references by other stations in enablement process in order to avoid possible service area extension beyond the permitted location boundaries and multiple chains of dependencies on enablement service area.

Information may be exchanged between a dependent station and an enabler in the form of an enablement request frame. Examples of enablement request frames are disclosed in FIG. 8A. In this example FCC database 800 may first provide information to enabler 802. The request sent from enabler 802 may include location information (e.g., information identifying the current position of enabler 802). The response sent from FCC database 800 to Enabler 802 may include at least allowed frequency information pertaining to the area in which the enabler 802 is operating. In the example of FIG. 8A, enabler 802 and dependent stations 804 may exist in the same apparatus as represented by dotted line 806 (such as in an AP per the example of FIG. 5A).

Dependent station 804 may then receive an enabling signal. This signal is sent by enabler 802 in the example of FIG. 8A, but this is not a requirement as will be seen in examples that follow in FIG. 8A-8E. Dependent station 804 may then request permission to operate in the TVWS environment by transmitting an Enablement request frame to enabler 802. There may be at least two types of enablement request frame: open protocol request frames and vendor-specific request frames. In accordance with the example shown in FIG. 8A, open protocol request frames may require dependent station 804 to provide identity information, desired apparatus type such as a beaconing-type apparatus or non-beaconing-type apparatus, and current location (or a reference to a first tier beaconing station). Dependent station 804 location may include latitude, longitude and altitude information (e.g., in LCI format specified by IETF RFC 3825) obtained, for example, via global positioning system (GPS), cell-based triangulation, location relative to other apparatuses (e.g., via direction-of-arrival estimation), etc. if such functionality is available in dependent station 804. However, if dependent station 804 does not include functionality for determining its position, and an enabling signal was received from a first tier beaconing device, then a reference to the first tier beaconing device may be sufficient for enabling. This is because the first tier beaconing device must have provided positing information when it was enabled, and thus, it is possible for the enabler to derive the approximate position of dependent station 804 based on the reference to the first tier beaconing apparatus in the enablement request frame.

Vendor-specific request frames may provide the same information as open protocol request frames but some of the information may be obtained in a proprietary manner. For example, in some deployment scenarios a preconfigured mapping may exist between dependent station 804 and enabler 802. In this case it may not be necessary to provide location information for dependent station 804 to the enabling entity for its database access. The MAC address of dependent station 804 may already be mapped to the identity and location assertion by enabler 802 as a result of enabler 802 performing additional signaling exchanges through upper layers or other means (e.g., additional security exchanges, such as by using radius protocol for authentication, may be utilized for identity and location assertion of the dependent stations).

Based on the type of dependent station 804 requesting enablement, the location information may have different scope requirements, and may be provided in different ways. A first tier beaconing apparatuses may provide location either from its own positioning resources or should have pre-configured relationship with the enabling entity indicated by the enablement type field (vendor-specific). Second tier beaconing apparatuses may provide location based on its own positioning resources or position information it derives from enabling signals transmitted within the service area of other devices. For a non-beaconing device, the location information is not necessary. For vendor-specific enablement request frames location information is optional, as location may be derived from preconfigured settings between enabler and dependent station.

Any enabling signals transmitted in a beacon signal from dependent station 804 may contain the MAC address of enabler 802. An important benefit from such enabling signals is to facilitate enablement of other dependent stations by the same enabling entity. Instead of having to first listen to signals (such as a beacon from an AP) containing regulatory class and channel information and then later having to switch to the channel in order to receive the enabling signal directly from the enabler, dependent stations can already begin enablement procedure with the enabling entity by using the address included in the beacon signals. The address of the enabler is inserted to the enabling signal sent by the beaconing device. This allows other apparatuses to send enablement request frames directly to the enabler via the beaconing dependent station using the address information obtained from the enabling signal. Alternatively, in one implementation such beaconing dependent stations may transmit their own address as the valid responder address of the enabling station. In this case, when beaconing stations receive enablement request frames they will forward them directly to the enabler, to which it is necessary to maintain a continuous communication link during its TVWS operation.

In terms of specific WLAN implementations, when the enabler is not part of the WLAN BSS/IBSS, or is not itself a wireless device, its operation during database query depends on the relative distance of the wireless network it will be enabling to its actual location. Enablers may be in close proximity to the stations of the WLAN network or may be located remotely from the wireless BSS or IBSS for which it authorizes client devices to operate in TVWS. Enablers may substitute its own coordinates for location configuration information (LCI) while doing database query to the FCC's database. When the enabler is located close to the BSS or IBSS, it can use preconfigured service area information or determine the expected service area coverage that can be initiated through dependent station beacons in view of location information received from beaconing dependent stations. Remote enablers may create one or more instances of registered device identities to database for creating one or more service areas based on the location of beaconing devices. The enablement service area may need to be created dynamically based on the received request from dependent beaconing devices, in which case, the enabling entity may utilize additional upper layer signaling exchanges to the database or to the dependent stations to ascertain the unique mapping of identity and service area. The enabler may be the single point of contact from database side for all dependent stations in those service areas.

### V. Examples of Messaging in TVWS Systems

In accordance with at least one embodiment of the present invention, FIG. 8B-8E discloses example message exchanges that may occur during enablement of first tier beaconing apparatuses, second tier beaconing apparatuses and non-beaconing TVBD. The example interactions shown in these figures are intended only for explaining broader concepts disclosed herein, and thus, are not intended to limit the various embodiments of the present invention.

FIG. 8B discloses an example messaging exchange between FCC database 800, an intermediate beaconing apparatus (e.g., AP) 810 and a non-beaconing apparatus 808. In this scenario, enabler 802 may provide enablement services for at least the immediate TVWS area including dependent station 804 residing in AP 810 along with enabler 802 and non-beaconing station 808. Initially, FCC database 800 may interact with enabler 802 in AP 810 in order to provide at least allowed channel information (e.g., allowed frequencies that may be utilized for TVWS operation) to enabler 802. This information may be provided by request or periodically, such as on a daily basis. From the DSE perspective, the enablement of dependent station 804 may be run internally in AP 810 between enabler 802 and dependent station 804. In particular, after receiving an enabling signal from enabler 802 dependent station 804 may transmit an open protocol or vendor-specific enablement request frame to enabler 802. The enabling signal may be used to trigger such exchanges as it may contain address information useful in the enablement process, but whether or not an enabling signal is required may vary depending on how particular communication systems are being implemented. Even though enabler 802 and dependent station 804 are collocated in AP 810, the current location of dependant station 804 may still be required for open protocol enablement requests because location sensitivity may not allow enabler 802 to recognize this relationship (e.g., enabler 802 may be an entity created with third-party software that may be oblivious to the location where it is installed). In response to the enablement request frame, dependent station 804 may receive enablement information from enabler 802 designating dependent station 804 as a first tier or second tier beaconing apparatus. At least some of the enablement information may then be used for configuring communications in dependent station 804 including at least beacon signal content, transmission strength, etc.

AP 810 may then become visible over the air to other devices like non-beaconing station 808 be transmitting beacon signals. In view of the previous enablement procedure, the beacon signal may contain one or more indicators that flag enabling signal information such as a DSERegLoc information element (IE) being set to “1” and a Dependent STA IE being set to “0” in transmitted beacon signals. Further, since enabler 802 is contained within AP 810, the address of AP 810 (e.g., “own location” in FIG. 8B since the beacon from AP 810 is advertising its own location) may be included in beacon signals along with one or more allowed channels which TVBD may utilize to communicate. Non-beaconing apparatus 808 may receive this information in the beacons transmitted from AP 810, and may utilize it to transmit an enablement request frame to enabler 802. For example, non-beaconing apparatus may discern from the beacon information that enabler 802 is located in AP 810 and may be accessed via WLAN over at least the identified allowed channels. Non-beaconing apparatus 808 may then utilize WLAN communication to send an enablement request frame to enabler 802, and enabler 802 may respond to non-beaconing station 808 with permission to operate in TVWS for the particular geographic area managed by enabler 802. For example, enablement information received by non-beaconing station 808 may include frequencies and boundary requirements that control when non-beaconing apparatus 808 must again request permission for TVWS operation. It is further important to note that one or all of the example apparatuses disclosed in FIG. 8B may also need to perform sensing for legacy apparatus operation in accordance with FCC rules.

FIG. 8C discloses a scenario similar to FIG. 8B except in this instance enabler 802 is located remotely from the first intermediary beaconing apparatus (e.g., dependent station 804 in AP 810). The initial interaction between FCC database 800 and enabler 804 may proceed in a manner similar to FIG. 8B. Enabler 802 may be located near the BSS or IBSS to be formed by dependent station 804, or may be located remotely within a larger infrastructure. This may occur because enabler 802 does not actually have to be an apparatus, but may instead be an entity residing, for example, on a server in a corporate or governmental network. In FIG. 8C dependent station 804 may access enabler 804 via a wired connection (e.g., over a LAN or WAN like the Internet). However, this configuration is not necessary and is not meant to limit embodiments of the present invention. After receiving an enabling signal, dependent station 804 may transmit an enablement request frame to enabler 802 via the wired connection, and in response, may receive enablement information. In some cases the enablement request frame may not include location information depending on the configuration of the network and the relationship between enabler 802 and dependent station 804. For example, the wired connection may allow enabler 802 to approximate the location of dependent station via network management resources, or in the instance of vendor-specific enablement request frames, the location of dependent station 804 may be available from other proprietary processes and/or higher level management activities occurring between the devices. Otherwise, current apparatus location will need to be provided when open format enablement request frames are being transmitted. At least some of the received enablement information may then be usable for configuring TVWS operation in dependent station 804, such as for setting transmission power level and beaconing content.

Dependent station 804 may then transmit beacon signals. The content of the beacon signals, as set forth in FIG. 8C, may include a DSERegLoc IE being set to “1” and a Dep STA IE being set to “1” to indicate to receiving devices the relationship of beaconing station 804 to enabler 802. The beacons signals may also contain the location of enabler 802 (e.g., the MAC address where enabler 802 may be accessed) and an indication of one or more allowed channels on which TVWS may proceed. Using this information, non-beaconing apparatus 808 may access enabler 802. As represented by “pipe” 812 in FIG. 8C, non-beaconing apparatus 808 may access enabler 802 using WLAN or any other wired or wireless communication medium that is available to the apparatus. For example, non-beaconing apparatus 808 may have wired/wireless connections to the Internet, connections to a corporate LAN on which the server that is hosting enabler 802 resides, etc. Regardless, non-beaconing apparatus 808 may request permission to operate using WLAN in the TVWS area managed by enabler 802, and upon receiving permission from enabler 802 may operate in the TVWS area in accordance with the conditions set forth in the enablement information (e.g., allowed frequencies and geographical boundaries) and FCC provisions (e.g., sensing requirements for avoiding interference with legacy apparatus operation).

Example 8D explains apparatus interaction in a situation where enabler 802 and dependent station 804 are linked via a wireless connection. For example, dependent station 804 may reside in a mobile wireless apparatus that can quickly change location. After receiving an enabling signal, if needed, dependent station 804 must request enablement by means of either an open protocol or vendor-specific protocol enablement request frame, and since dependent station 804 resides within a mobile/portable device whose location is not obvious for the enabler device (unlike the previous example where dependent station 804 was stationary) the mobile/portable device typically needs to provide its current location to the enabler. This communication may be conducted via WLAN or another wireless transport. Dependent station 804 may then receive enablement information from enabler 804. It is important to note that in this example dependent station 804 can only be enabled as a second tier beaconing apparatus. The location of dependent station 804 is variable, and thus, it may be possible for dependent station 804 to operate near the boundary of the TVWS area (e.g., sub-area 606 in FIG. 6). In order to prevent beaconing signals from being transmitted outsides of the TVWS area, the more restrictive second tier beaconing mode is designated for the apparatus.

The remaining interaction in FIG. 8D is similar to FIG. 8C. While a previous example stated that in some cases second tier beaconing apparatuses may not transmit enabling signals in their beacons, this is merely an enablement parameter that can vary depending on the particular TVWS area. For example, if the particular TVWS area is large or does not contain many beaconing devices, then second tier beaconing apparatuses may be permitted to transmit enabling information in their beacon signals. Similar to the previous example, the beacon signals may include the location of enabler 802. Non-beaconing apparatus 808 may utilize this location information to access enabler 802 via a WLAN D2D network or other communication link for transmitting an enablement request frame and receiving permission to operate in the TVWS area.

FIG. 8E discloses an interaction where there are two intermediary beaconing apparatuses designated as first tier and second tier apparatuses, respectively. Initially, FIG. 8E presumes that enabler 802 has already interacted with FCC database 800 in order to receive the allowed channel information pertaining to the certain TVWS area under control of enabler 802. Dependent station 804 may then interact with enabler 802 in order to become enabled. As set forth in the previous examples, this interaction may include transmitting open or vendor-specific enablement request frames to the enabler after receiving an enabling signal (if enabling signals are required). These enablement request frames may not have to include position information depending on the type of frame transmitted, the prior relationship between enabler 802 and dependent station 804, etc. Enabler 802 may then respond with enablement information that designates dependent station 804 as a first tier beaconing apparatus. First tier beaconing apparatus 804 may then transmit beacons including enabling information to other apparatuses in the TVWS area. The beacons may contain information that indicates the beacons contain enabling information (e.g., DSERegLoc IE=1, Dep STA IE=1), which may be followed by information indicating the location of enabler 802 and allowed channel information.

In this instance a second dependent station 814 that desires to perform beaconing forms a D2D wireless network with first tier beaconing apparatus 804. Dependent station 814 may then transmit an enablement request frame to enabler 802 via WLAN or another wired or wireless communication transport. It is important to note that even if dependent station 814 does not include the ability to provide positioning information to enabler 802 that enablement may still occur. Initially, dependent station 814 may utilize a vendor-specific enablement request frame that eliminates the need for dependent station 814 to provide location information. This may occur because dependent station 814 have a pre-established relationship with enabler 802, or alternatively, because enabler 802 may obtain the location of dependent station 802 from proprietary network-related to device-related management resources. Even if a preexisting relationship does not exist and a vendor-specific request frame cannot be used enablement may still be supported for dependent station 814. In some instances, dependent station 814 may leverage the relationship already established between first tier beaconing device 804 and enabler 802 in order to request enablement. For example, dependent station 814 may transmit an open enablement request frame to enabler 802 that references dependent station 804 (the first tier beaconing device). In some instances it may also be possible for dependent station 814 to just transmit an enablement request frame to first tier beaconing apparatus 804, and first tier beaconing apparatus 804 forwards the enablement request frame to enabler 802 after inserting some sort of identification that the request is coming through the first tier beaconing apparatus. In either instance, enabler 802 may derive the relative location of dependent station 814 from the fact that first tier beaconing station 804 has been referenced in the enablement request frame. This approximate location for dependent station 814 may be sufficient for registering dependent station 814 and enabling the device. Dependent station 814 may then be designated as a second tier beaconing device and may transmit beacon signals that may be received by other apparatuses such as non-beaconing apparatus 808. Non-beaconing apparatus 808 may utilize the enabling information from the beacon signal to access enabler 802 via a WLAN D2D network or another wired/wireless communication link for requesting enablement. Enabler 802 may then provide enablement information to non-beaconing apparatus 808 permitting WLAN operation within the TVWS area in view of the parameters in the enablement information and any other FCC rules.

### VI. Other TVWS Functionality

In TVWS frequency band, allowed channel availability is contingent upon the channels not being occupied by any primary services at all times. Therefore, it is foreseeable that enablers or beaconing devices may need to initiate channel switches to other available channels. In order to allow enablement in the new channel faster two methods are proposed: the enabling signal from a beaconing station may contain information about backup channels or the enabling signal from a beaconing station can include information of a set of other available TV channels for use based on the information obtained from the enabler through its database access. For example, one available channel can be selected by beaconing stations as a backup channel for operation when currently operated channels become unavailable to use. Enabling signals can contain information of one or more backup frequency channels for switchover. The bandwidth of such channel(s) to be used after channel switchover may also be included in such message.

In accordance with at least one embodiment of the present invention, enablement for multiple allowed channels may also be supported. The enabling signal from an enabler or a dependent beaconing station may additionally identify other frequency channels for which enablement can also be offered by the enabler. This may provide faster channel switching opportunity without having to again initiate enablement for each channel at the time of switching to the new channel. The enablement request and response frame exchange between enabler and dependent stations may include information indicating whether the enablement request for more than one channel is supported, and the list of allowed channels for which the enablement has been requested by the enablement request or granted by the enablement response message.

Enabling signal transmission may also be supported in scenarios where dependent stations are using non-WLAN connectivity to the enabling device. In some deployments the enabling device may be another node that is not part of the WLAN BSS or IBSS network. There may also be situations where personal/portable devices do not include positioning resources or Internet connectivity to reach to the central database and thus can not operate in a master mode. At the same time, devices may be connected to enablers through other backbone connections such as wired connections or by a cellular link. When a dependent station has knowledge of the availability of an enabler, it may choose to have an on-demand request for enabling signal. This includes sending a request for enabling signal to its enabling station. If the requesting station has already performed background spectrum sensing or gathered possible list of available channels around its area, it may also include one or more specific channels it would like to utilize in the enablement request frame. In response, enablers may offer enablement in the channel indicated, may deny the request or may send an enabling signal indicating a channel for which permission may be granted. The request message may be sent as a public action frame (class 1 frames) that may be relayed via other WLAN stations without the need of being associated to the network.

Alternatively, an enablement request frame may be transmitted without the need of prior reception of an enabling signal. Based on the apparatus capability, knowledge of TVWS channels on which the apparatus most likely can operate (such as based on earlier operation in same location) may be obtained. An enablement request frame may then be sent directly to an enabler without first receiving enabling signals. Dependent stations may already have performed mandatory TV availability check time in that channel. When such enablement for the channel is granted by enablers, the operation in the TVWS channel can commence quickly (based on the result of database query for the location). If the enabler determines that it can not enable in the channel requested, it may send an enabling signal indicating only the channels on which it can currently offer enablement instead of responding with the enablement response frame.

Enabling signals may also be requested for in-service monitoring (or operation control) of the dependent stations. In order to maintain continuous control between of enablers over dependent stations, each dependent station must receive enabling signals periodically within a given known interval, which is 60 seconds based on 802.11y specification, as well as per the current FCC rules in U.S. To meet such in-service monitoring requirements, dependent stations may either have to switch to other frequency bands (or to other connection media) and listen for the signals for certain duration, or passively scan the channel where enabling signal can be heard. Such actions are necessary when dependent stations are connected to enablers through other frequency bands or by other media. On-demand requests for enabling signals may provide more flexibility to the dependent station for in-service monitoring or operation control. Enabling signals for the purpose of in-service monitoring can be requested from dependent stations periodically or whenever it intends to receive it from the enabler. Such requests may indicate that the request is for in-service monitoring or operational control, and may also contain a periodic interval within which the enabling signal is expected, unless a new request signal will be sent by the requesting station. This may be useful in many cases in which the enabling signal can not be delivered as part of the beacon or other frames transmitted in the current channel of operation. Connections to enablers may be used as required for this purpose. Dependent stations may transmit request messages for enabling signals to the enabler through other radio channels or by other media whenever such signals are needed, which can be also optimized for current traffic load or network resource availability.

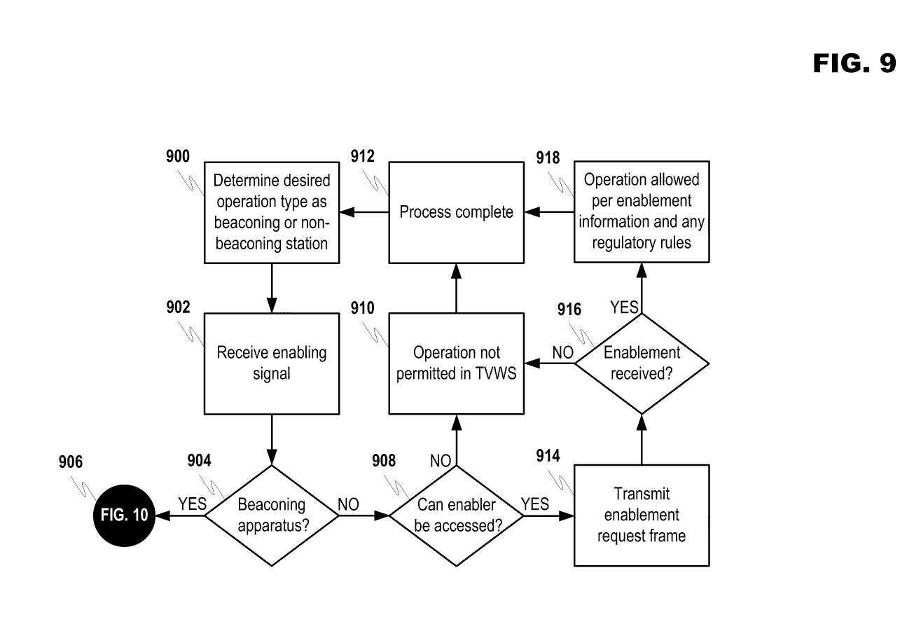

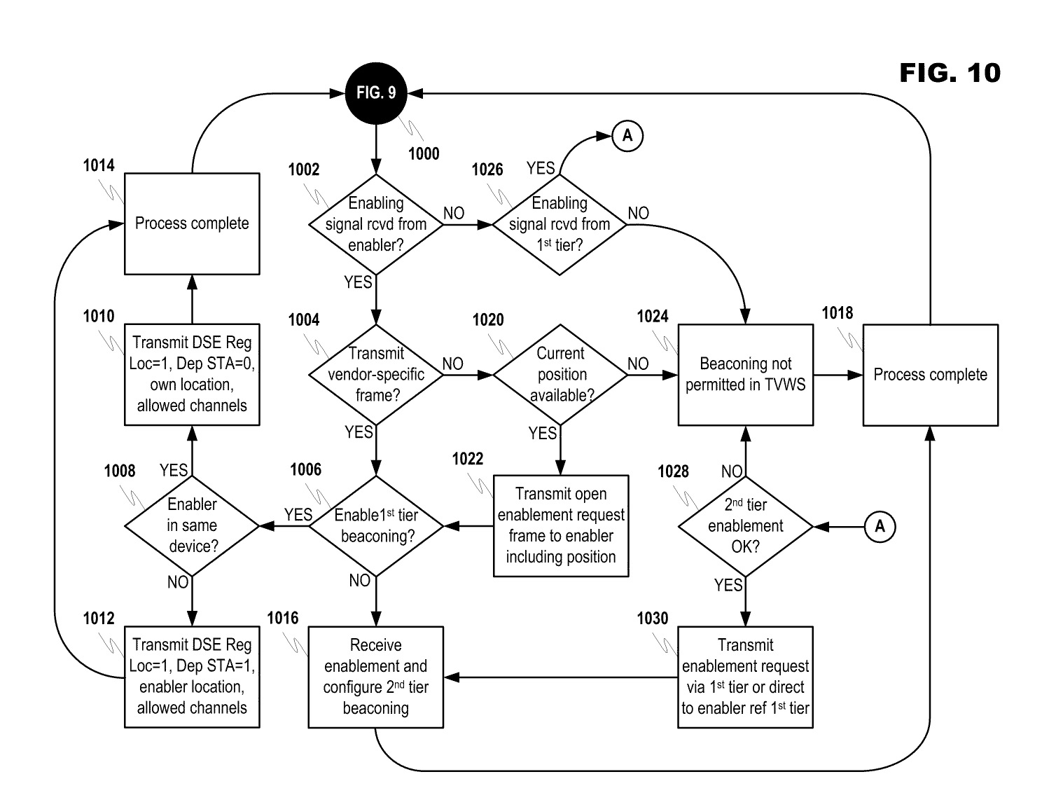

A flowchart of an example process for enabling WLAN operation within a TVWS area in accordance with at least one embodiment of the present invention is disclosed in FIG. 9. Again, while WLAN has been referenced specifically in this process flow, the use of WLAN is for explanation only as other similar wireless communication mediums may also benefit from such operations. In step 900 WLAN a determination may be made in an apparatus as to whether operation as a beaconing-type apparatus or a non-beaconing-type apparatus is desired, which may be followed by an enabling signal being received in step 902. As previously discussed, the use of enabling signals for initiating apparatus enablement processes may be beneficial because the address of the enabler may be provided in the enabling signal, but their use may be optional as address of the enabler may also be obtained from other sources. A determination may then be made in step 904 as to whether the apparatus is a beaconing-type apparatus (e.g., an apparatus that desires to transmit beacon signals). If the apparatus is determined to be a beaconing-type apparatus the process may move to the flowchart of FIG. 10 (step 906). Otherwise, based on location information in the received enabling signal the apparatus may then determine in step 908 whether access to the enabler can be established via WLAN or another wired or wireless communication transport. If access cannot be established then in step 910 WLAN operation in the particular TVWS area managed by the enabler is not permitted. The process may terminate in step 912 and then return to step 900 to prepare for the next WLAN communication in TVWS.

If in step 908 access to the enabler can be established, then in step 914 an open or vendor-specific enablement request frame may be transmitted to the enabler. If in step 916 no enablement information is received in response to the enablement request frame, then in step 910 permission is again denied for the apparatus to communicate via WLAN in the particular TVWS area. Otherwise, the process may proceed to step 918 where enablement information is received and WLAN operation is allowed in the particular TVWS area managed by the enabler in view of the configuration parameters established in the enablement information (e.g., allowed channels) and, if applicable, any other regulatory rules that might apply like the FCC sensing requirements for legacy TVWS apparatus operation. The process may then be complete in step 912 and may return to step 900 in preparation for the next WLAN communication in TVWS.

If in step 902 a determination was made that the apparatus seeking permission for TVWS operation desires to transmit beacon signals in WLAN, then the process may move to the flowchart of FIG. 10 where the process initiates at bridge 1000. In step 1002 a determination may be made as to whether the enabling signal received at step 902 was received directly from an enabler. If it is determined that the signal was received directly from an enabler, then in step 1004 a further determination may be made as to whether a vendor-specific enablement request frame may be transmitted in response to the enabling signal. This determination may be based on, for example, a previous and/or proprietary relationship existing between the enabler and the requesting apparatus. If a vendor-specific enablement request frame is transmitted in step 1004, then in step 1006 enablement information may be received from the enabler in response to the vendor-specific enablement request frame, and a determination may be made as to whether the received enablement information designates the requesting apparatus as a first tier or second tier beaconing apparatus. The enabler may designate the requesting apparatus as a first tier or second tier beaconing apparatus based on a variety of criteria. For example, a current location for the requesting apparatus, regardless of whether derived based on prior relationship, proprietary information or an actual current location provided by the requesting apparatus, may be deemed too close to a boundary of the TVWS area. Designating the requesting apparatus as a first tier beaconing apparatus in such cases risks enabling signals being transmitted outside of the TVWS area, and thus, the requesting apparatus may be designated as a second tier beaconing apparatus.

If it is determined that the enablement information designates the apparatus as a first tier beaconing apparatus in step 1006, then a determination may then be made in step 1008 as to whether the enabler is located in the same apparatus as the requesting apparatus (e.g., the requesting entity is actually a dependent station located in the same apparatus, such as an AP, as the enabler). If the enabler and the requestor are both located in the same apparatus, then in step 1010 a beacon signal may be configured including indication information such as DSERegLoc IE=1, Dependent STA IE=0, the location (e.g., address) of the requesting apparatus (since the enabler and requestor are collocated) and one or channels (e.g., frequencies) on which WLAN operation is allowed for the particular TVWS area. If the enabler and the requesting apparatus are not located in the same apparatus, then in step 1012 the beacon signal may instead indicate DSERegLoc IE=1, Dependent STA IE=1, the location (e.g., address) of the enabler and one or channels (e.g., frequencies) on which WLAN operation is allowed for the particular TVWS area. Regardless of how the beacon signal may be configured in step 1010 or 1012, the process may then be complete in step 1014 and may return to step 900, via bridge 1000, in preparation for the next apparatus desiring to operate as a beaconing-type or non-beaconing type apparatus.

If in step 1006 it is determined that the enablement information has designated the requesting apparatus as a second tier beaconing apparatus, then the process may proceed to step 1016 where the requesting apparatus is configured as a second tier beaconing apparatus. This configuration may allow the apparatus to transmit beacon signals within the TVWS area, but in accordance with at least one embodiment of the present invention, these beacon signals may not include enabling signals. The process may then terminate in step 1018 and return to step 900, via bridge 1000, in preparation for the next apparatus desiring to operate as a beaconing-type or non-beaconing type apparatus. Returning to step 1004, if it is determined that a vendor-specific frame will not be transmitted, a determination may then be made in step 1020 as to whether current position information is available for the requesting apparatus. Current apparatus position information may be provided by resources in the apparatus like GPS or cell-triangulation, or may in some instances be available from a network to which the apparatus is connected. If current position information is determined to be available for the apparatus in step 1020, then in step 1022 an open format enablement request frame may be transmitted to the enabler, and the process may proceed from step 1006 as previously described. On the other hand, if in step 1020 it is determined that current position information is not available for the requesting apparatus, then no open format enablement request frame can be transmitted, and beaconing in the TVWS area for the apparatus may not be permitted in step 1024. The process may then proceed to step 1018 where the process terminates and returns to step 900, via bridge 1000, in preparation for the next apparatus desiring to operate as a beaconing-type or non-beaconing type apparatus.

Returning to step 1002, if it is determined that an enabling signal was not received directly from the enabler, then in step 1026 a further determination may be made as to whether an enabling signal has been received from a first tier beaconing apparatus. If no enabling signal was received in step 1026, then beaconing may not be permitted in step 1024. The process may then proceed to step 1018 where the process terminates and returns to step 900, via bridge 1000, in preparation for the next apparatus desiring to operate as a beaconing-type or non-beaconing type apparatus. In accordance with at least one embodiment of the present invention, if an enabling signal is received from a first tier enabling apparatus, then the receiving apparatus may only be enabled as a second tier beaconing apparatus. In view of this condition, a determination may be made in step 1028 as to whether the apparatus that received the enabling signal from the first tier beaconing device actually desires to operate as a second tier beaconing apparatus. If the apparatus does not desire to operate as a second tier beaconing apparatus, then beaconing may not be permitted in step 1024. The process may then proceed to step 1018 where the process terminates and returns to step 900, via bridge 1000, in preparation for the next apparatus desiring to operate as a beaconing-type or non-beaconing type apparatus. Otherwise, in step 1030 the apparatus may transmit an enablement request frame to the first tier beaconing apparatus, which may modify the enablement request frame (e.g., insert identification information) to associate the requesting apparatus with the first tier beaconing apparatus. The first tier beaconing apparatus may then forward the modified enablement request frame to the enabler. Another option may be for the requesting apparatus to transmit an enablement request frame including a reference to the first tier beaconing apparatus directly to the enabler. It is important to note that transmitting enablement request frames referencing a first tier beaconing apparatus does not override or eliminate the previously existing options of transmitting a vendor-specific enablement request frame or an open enablement request frame including current apparatus position information if these formats are available. The option of referencing the first tier beaconing apparatus is merely a feature that allows apparatuses without the resources for determining their current position another possibility for becoming enabled. Regardless of how the enablement request frame is transmitted, the process may then return to step 1016 and proceed as previously disclosed.

While various exemplary configurations of the present invention have been disclosed above, the present invention is not strictly limited to the previous embodiments.

For example, an embodiment the present invention may include, in accordance with at least one example embodiment, an apparatus comprising means for initiating communication activities in an apparatus by determining whether the apparatus desires to be a beaconing type apparatus or a non-beaconing type apparatus, means for transmitting an enablement request frame from the apparatus, the enablement request frame comprising at least apparatus identification information and the desired beaconing or non-beaconing apparatus type, means for receiving enablement information in the apparatus in response to the enablement request frame, the enablement information at least designating the apparatus as a first tier beaconing apparatus, a second tier beaconing apparatus or a non-beaconing apparatus, and means for configuring the apparatus based on the enablement information.

At least one other example embodiment of the present invention may include electronic signals that cause apparatuses to initiate communication activities in an apparatus by determining whether the apparatus desires to be a beaconing type apparatus or a non-beaconing type apparatus, transmit an enablement request frame from the apparatus, the enablement request frame comprising at least apparatus identification information and the desired beaconing or non-beaconing apparatus type, receive enablement information in the apparatus in response to the enablement request frame, the enablement information at least designating the apparatus as a first tier beaconing apparatus, a second tier beaconing apparatus or a non-beaconing apparatus, and configure the apparatus based on the enablement information.

Accordingly, it will be apparent to persons skilled in the relevant art that various changes in form a and detail can be made therein without departing from the spirit and scope of the invention. The breadth and scope of the present invention should not be limited by any of the above-described example embodiments, but should be defined only in accordance with the following claims and their equivalents.

What is claimed:

1. A method, comprising:
initiating communication activities in an apparatus by determining whether the apparatus desires to be a beaconing-type apparatus or a non-beaconing-type apparatus;
transmitting an enablement request frame from the apparatus, the enablement request frame comprising at least apparatus identification information and the desired apparatus type;
receiving enablement information in the apparatus in response to the enablement request frame, the enablement information at least designating the apparatus as a first tier beaconing apparatus, a second tier beaconing apparatus or a non-beaconing apparatus; and
configuring the apparatus based on the enablement information.

2. The method of claim 1, wherein the beaconing apparatus type corresponds to apparatuses transmitting beacon signals in IEEE 802.11 (WLAN) wireless communication protocol.

3. The method of claim 1, wherein the enablement request frame is either an open format enablement request frame or a vendor-specific enablement request frame, the open format enablement request frame further comprising current apparatus location information.

4. The method of claim 1, further comprising receiving an enabling signal in the apparatus, wherein if the enabling signal is received from an enabler the enablement request frame is transmitted from the apparatus to the enabler.

5. The method of claim 1, further comprising receiving an enabling signal in the apparatus, wherein if the enabling signal is received from a first tier beaconing apparatus the enablement request frame is either transmitted from the apparatus to the first tier beaconing apparatus or the enablement request frame is transmitted from the apparatus to an enabler including a reference to the first tier beaconing apparatus.

6. The method of claim 1, wherein the apparatus is configured to transmit enabling signals to other apparatuses when the apparatus is designated as a first tier beaconing apparatus.

7. The method of claim 1, wherein the apparatus is configured with a higher transmission power level when the apparatus is designated as a first tier beaconing apparatus as compared to when the apparatus is designated as a second tier beaconing apparatus.

8. A computer program product comprising computer executable program code recorded on a non-transitory computer readable storage medium, the computer executable program code comprising:
code configured to cause an apparatus to initiate communication activities by determining whether the apparatus desires to be a beaconing-type apparatus or a non-beaconing-type apparatus;
code configured to cause the apparatus to transmit an enablement request frame, the enablement request frame comprising at least apparatus identification information and the desired apparatus type;
code configured to cause the apparatus to receive enablement information in response to the enablement request frame, the enablement information at least designating the apparatus as a first tier beaconing apparatus, a second tier beaconing apparatus or a non-beaconing apparatus; and
code configured to cause the apparatus to configure itself based on the enablement information.

9. The computer program product of claim 8, wherein the beaconing apparatus type corresponds to apparatuses transmitting beacon signals in IEEE 802.11 (WLAN) wireless communication protocol.

10. The computer program product of claim 8, wherein the enablement request frame is either an open format enablement request frame or a vendor-specific enablement request frame, the open format enablement request frame further comprising current apparatus location information.

11. The computer program product of claim 8, further comprising code configured to cause the apparatus to receive an enabling signal, wherein if the enabling signal is received from an enabler the code is further configured to cause the enablement request frame to be transmitted from the apparatus to the enabler.

12. The computer program product of claim 8, further comprising code configured to cause the apparatus to receive an enabling signal, wherein if the enabling signal is received from a first tier beaconing apparatus the code is further configured to cause the enablement request frame to either be transmitted from the apparatus to the first tier beaconing apparatus or the enablement request frame to be transmitted from the apparatus to an enabler including a reference to the first tier beaconing apparatus.

13. The computer program product of claim 8, wherein the code is further configured to cause the apparatus to be configured to transmit enabling signals to other apparatuses when the apparatus is designated as a first tier beaconing apparatus.

14. The computer program product of claim 8, wherein the code is further configured to cause the apparatus to be configured to have a higher transmission power level when the apparatus is designated as a first tier beaconing apparatus as compared to when the apparatus is designated as a second tier beaconing apparatus.

15. An apparatus, comprising:
at least one processor; and
at least one memory including executable instructions, the at least one memory and the executable instructions being configured to, in cooperation with the at least one processor, cause the apparatus to perform at least the following:
initiate communication activities by determining whether the apparatus desires to be a beaconing-type apparatus or a non-beaconing-type apparatus;
transmit an enablement request frame, the enablement request frame comprising at least apparatus identification information and the desired apparatus type;
receive enablement information in response to the enablement request frame, the enablement information at least designating the apparatus as a first tier beaconing apparatus, a second tier beaconing apparatus or a non-beaconing apparatus; and
configure itself based on the enablement information.

16. The apparatus of claim 15, wherein the beaconing apparatus type corresponds to apparatuses transmitting beacon signals in IEEE 802.11 (WLAN) wireless communication protocol.

17. The apparatus of claim 15, wherein the enablement request frame is either an open format enablement request frame or a vendor-specific enablement request frame, the open format enablement request frame further comprising current apparatus location information.

18. The apparatus of claim 15, wherein the at least one memory and the executable instructions are further configured to, in cooperation with the at least one processor, cause the apparatus to receive an enabling signal, wherein if the enabling signal is received from an enabler the at least one memory and the executable instructions being further configured to, in cooperation with the at least one processor, cause the enablement request frame to be transmitted from the apparatus to the enabler.

19. The apparatus of claim 15, wherein the at least one memory and the executable instructions are further configured to, in cooperation with the at least one processor, cause the apparatus to receive an enabling signal, wherein if the enabling signal is received from a first tier beaconing apparatus, the at least one memory and the executable instructions being configured to, in cooperation with the at least one processor, cause the enablement request frame to either be transmitted from the apparatus to the first tier beaconing apparatus or the enablement request frame to be transmitted from the apparatus to an enabler including a reference to the first tier beaconing apparatus.

20. The apparatus of claim 15, wherein the at least one memory and the executable instructions are further configured to, in cooperation with the at least one processor, cause the apparatus to be configured to transmit enabling signals to other apparatuses when the apparatus is designated as a first tier beaconing apparatus.

21. The apparatus of claim 15, wherein the at least one memory and the executable instructions are further configured to, in cooperation with the at least one processor, cause the apparatus to be configured with a higher transmission power level when the apparatus is designated as a first tier beaconing apparatus as compared to when the apparatus is designated as a second tier beaconing apparatus.
